(19) United States
(12) Patent Application Publication
(10) Pub. No.: US 2024/0409755 A1
(43) Pub. Date: Dec. 12, 2024

(54) COATING RESISTANT TO BIOGROWTH PARTICULARLY IN MARINE ENVIRONMENTS

(71) Applicant: CORE INDUSTRIES II, LLC, Palm Beach Gardens, FL (US)

(72) Inventors: Louis C. COSENTINO, Excelsior, MN (US); Jackson BENDA, Golden Valley, MN (US)

(21) Appl. No.: 18/732,935

(22) Filed: Jun. 4, 2024

Related U.S. Application Data
(60) Provisional application No. 63/471,436, filed on Jun. 6, 2023.

(51) Int. Cl. C09D 5/16; C08K 5/00; C08K 5/136; C08K 5/3415; C09D 163/00

(52) U.S. Cl. CPC C09D 5/1687; C09D 5/1662; C09D 163/00; C08K 5/0091; C08K 5/136; C08K 5/3415; C08K 2201/019

(57) ABSTRACT

Improved antifouling coatings for marine vessels are provided comprising a brominated epoxy resin. An antifouling composition is provided comprising a brominated epoxy resin, one or more copper-free and tri-organotin-free antifouling agents, optionally a surface additive, and further optionally a brominated additive. The antifouling compositions reduce hull fouling to improve the fuel efficiency and increase the speed of vessels, and decrease downtime required for recoating.

### CROSS-REFERENCES TO RELATED APPLICATIONS

This application claims the benefit of U.S. Provisional Application No. 63/471,436 filed Jun. 6, 2023, which is incorporated by reference herein in its entirety.

### BACKGROUND

Marine organisms that adhere and grow on a ship's hull increase the hull's frictional coefficient with seawater. This marine organism fouling results in decreased vessel speed and increased fuel consumption.

Antifouling paints and coatings with biocides such as copper and tri-organotin compounds are well known but have raised environmental concerns and their use has been restricted by the U.S. Environmental Protection Agency (EPA) and other government pollution control agencies.

GB1396037 A, M&T International N.V., May 29, 1975, describes toxicant compositions comprising a tri-organotin compound, zinc oxide and a symmetrical triazine derivative for use in protective coatings, including anti-fouling paints.

U.S. Pat. No. 7,297,727, Arkema Inc., Nov. 20, 2007, describes an antifouling marine coating composition comprising erodible -[A]-[B]— polymers, where A comprises a triarylsilyl(meth)acryloyl group (—XSiR₃) where X is aryl or heteroaryl, X is acryloxy or methacryloxy group, and B is a residue of methyl methacrylate. The marine coating compositions may include toxicants such as inorganic toxicant compounds such as cuprous oxide, copper powder, copper thiocyanate, zinc sulfate, zinc oxide and the like, metal-containing organic toxicants such as zinc pyrithione, or metal-free organic toxicant compounds such as triazine compounds.

Improved antifouling coatings for marine vessels are desirable to reduce hull fouling, corrosion, improve fuel efficiency and speed of vessels. Extended life antifouling coatings also decrease valuable vessel downtime needed for cleaning and recoating the hull. Antifouling coating compositions that decrease hull fouling without the use of copper or tri-organotin or other toxic persistent derivatives are desirable. Reduction of fouling on other underwater surfaces such as the propellers, shafts, struts, trim tabs, intakes (through-hulls), intake covers, transducers, knotmeter, keel coolers, grounding plates, and line cutters, is also desirable.

### SUMMARY

Improved copper-free antifouling coatings for marine vessels are provided comprising a brominated epoxy resin. In some cases, the antifouling composition further comprises one or more or two or more copper-free and tri-organotin-free antifouling agents. In some cases, the antifouling composition further comprises a brominated additive. In some cases, the antifouling composition further includes a surface additive. The surface additive may lower the surface energy, lower adhesion, and improve foul-release. In some cases, the antifouling agents are copper-free and tri-organotin-free. The antifouling agents may be non-persistent antifouling agents. The antifouling compositions reduce hull fouling in order to help reduce the spread of invasive species, improve the fuel efficiency and increase the speed of vessels, and decrease downtime required for recoating.

In some cases, an antifouling coating composition is provided comprising a brominated epoxy resin, one or more antifouling agents, and optionally a brominated additive. In addition, the composition may comprise a surface additive to reduce adhesion of marine organisms to the coated surface. One or more copper-free antifouling agents, e.g., such as zinc pyrithione and/or tralopyril can be incorporated into the coating to enhance its antifouling properties. In some cases, the brominated epoxy resin may be a brominated epoxy resin dissolved in a suitable solvent.

In some cases, the brominated epoxy resin may exhibit an EEW on solids (g/eq) in a range of between 100 and 10,000, 200-5,000, 300-1,000, 305-470, 390-410, 425-445, 425-440, 465-495, 305-355, 440-470, or 350-370 g/eq by ASTM D-1652.

In some cases, the brominated epoxy resin may be made from a composition comprising 3,3′,5,5′-tetrabromobisphenol A and epichlorohydrin, or 2,2-bis[3,5-dibromo-4-(2,3-epoxypropoxy)phenyl]propane. In some cases, the brominated epoxy resin may be made from a composition comprising 3,3′,5,5′-tetrabromobisphenol A, bisphenol A, and epichlorohydrin.

In some cases, the brominated epoxy resin may include one or more additional additives selected from the group consisting of a solvent, curing agent, accelerator, plasticizers, diluents, defoaming agent, wetting agent, adhesion promoter, thixotropic agent, drying agents, coloring agents, and fillers commonly used in paints and coatings.

The optional brominated additive may be selected from the group consisting of a nonreactive brominated additive and a reactive brominated additive. The non-reactive brominated additive can be mixed with the brominated epoxy resin. In some cases, the reactive brominated additive may react with the brominated epoxy resin and is incorporated into its polymer structure.

In some cases, the brominated additive comprises a molecular weight of no more than 1500 g/mol, or no more than 1,000 g/mol, and 50-95 wt % Br or 55-80 wt % Br. In some cases, the brominated additive has a molecular weight in a range of 100-600 g/mol, 200-550 g/mol, or 543.87 g/mol.

The reactive brominated additive may include an aromatic reactive brominated additive, optionally selected from the group consisting of tetrabromobisphenol A, tetrabromophthalic anhydride, dibromostyrene, pentabromophenol, and tribromophenol. In some cases, the reactive brominated additive may be an aliphatic reactive brominated additive, optionally selected from bromoform, vinyl bromide, ethylene bromohydrin, and dibromoneopentyl glycol.

The brominated additive may include a nonreactive brominated additive. The nonreactive brominated additive may be selected from the group consisting of aromatic nonreactive brominated additives, aliphatic nonreactive brominated additives, and cycloaliphatic brominated additives.

The surface additive may be a silicone, hydrophilic modified polysiloxane, or other surface lowering energy, foul-release additive. The silicone surface additive may be selected from the group consisting of epoxy-functional silicones, hydroxy-functional silicones, and amine-functional silicones. The surface additive may be a functional polydimethylsiloxane. The functional polydimethyl siloxane may be selected from the group consisting of epoxy-functional polydimethylsiloxanes, hydroxy-functional polydimethylsiloxanes, and amine-functional polydimethylsiloxanes. In some cases, the surface additive comprises an epoxy-functional polydimethylsiloxane and a hydroxy-functional polydimethylsiloxane.

The antifouling composition may include a non-persistent antifouling agent. The antifouling agent may be a non-copper and non-tri-organotin biocide. In some cases, the antifouling agent is a non-copper and non-tri-organotin biocide selected from the group consisting of tralopyril (TLP, ECONEA®, JANSSEN PMP), 4-bromo-2-(4-chlorophenyl)-5-(trifluoromethyl)-1H-pyrrole-3-carbonitrile), bronopol (2-bromo-2-nitro-propane-1,3-diol), 2,2′-dibromo-3-nitrilopropionamide, bis(1,4-bromoacetoxy)-2-butene, bis-(bromomethyl)sulfone, 1,2-dibromo-2,4-dicyanobutane, benzyl 2-bromoacetate, tetrabromobenzo-1,3-dinitrile, 4,5-dichloro-2-n-octyl-4-isothiazolin-3-one (DCOIT)(SEA-NINE® 211N), LANXESS, N-(dichlorofluoromethylthio)-N′,N′-dimethyl-N-phenylsulamide (dichlofluanid, DCF, PREVENTOL® 4A-S, BAYER), bis(1-hydroxy-2(1H)-pyridinthionato-O,S) zinc, zinc pyrithione, (ZnPT, JANSSEN PMP), 3-(3,4-dichlorophenyl)-1,1-dimethylurea (DCMU, Diuron, Drexel Chemical Company), 4-(1-(2,3-Dimethylphenyl)ethyl)-1H-imidazole (medetomidine), and zinc ethylenebis(dithiocarbamate) (polymeric) (Zineb, AGRIA SA).

An antifouling coating composition is provided comprising 60-95 wt % of a brominated epoxy resin, 0-20 wt % of a brominated additive, 0-20 wt % of a surface additive, and 0-20 wt % of an antifouling agent. An antifouling coating composition is provided comprising 60-95 wt % of a brominated epoxy resin, 0-15 wt % of a brominated additive, 0-20 wt % of a surface additive, and 0.1-20 wt % of an antifouling agent. In some cases, the antifouling coating composition may comprise 60-90 wt % of a brominated epoxy resin, 0-20 wt % of a brominated additive, 0-20 wt % of a surface additive, and 1-20 wt % of an antifouling agent. In some cases, the brominated epoxy resin may be a solvent based brominated epoxy resin. In some cases, the brominated additive is an aromatic reactive brominated additive. In some cases, the surface additive comprises an epoxy-functional polydimethylsiloxane, a polyester-modified hydroxy-functional polydimethylsiloxane, hydrophilic modified non-reactive polysiloxane, polyether modified polysiloxane, and/or polypropylene modified polysiloxane. In some cases, the antifouling agent includes a non-persistent antifouling agent. In some cases, the antifouling agent includes a non-metallic antifouling agent. In some cases, the antifouling agent comprises tralopyril and zinc pyrithione. In some cases, the antifouling coating composition is a non-ablative antifouling composition.

A method of making an antifouling coating composition comprising dispersing a brominated epoxy resin in a solvent using high shear mixing; optionally adding one or more antifouling agents during the mixing; and optionally adding a surface additive during the mixing to provide the antifouling coating composition.

A method of making an antifouling coating composition is provided comprising dispersing a brominated epoxy resin in a solvent with one or more antifouling agents using high shear mixing; optionally adding a brominated additive during the mixing; optionally adding a surface additive during the mixing; and further optionally adding one or more additives selected from the group consisting of a solvent, curing agent, accelerator, elasticizer, diluent, defoaming agent, wetting agent, dispersing agent, surfactant, adhesion promoter, thixotropic agent, drying agent, filler, pigment, and coloring agent during the mixing.

A method of reducing fouling of a surface adapted to be submerged under water is provided, the method comprising applying an antifouling coating composition comprising a brominated epoxy resin to the surface while the surface is not submerged to provide an antifouling coating on the surface. In some cases, the antifouling coating is allowed to dry and/or cure prior to submerging the surface. In some cases, the water is seawater. In some cases, the water is freshwater. In some cases, the surface adapted to be submerged under water is selected from the group consisting of freshwater or marine vessel, hull, propeller, shaft, strut, trim tabs, intake, intake cover, transducer, knotmeter, keel cooler, grounding plate, line cutter dock, oil rig, crane, support structure, and buoy. In some cases, the antifouling coating on the surface is self-ablative and self-polishing in seawater.

A method of reducing fouling of underwater surfaces of a hull of a freshwater or marine vessel is provided, the method comprising exposing at least a portion of the hull above and below the waterline; applying the antifouling coating composition to at least a portion of the exposed hull; and allowing the composition to dry/cure to form coated underwater surfaces. The method may further include preparing the surface of the exposed hull prior to the applying, wherein the preparing comprises chemical, thermal and/or mechanical preparation of the exposed hull.

In some cases, the coated underwater surfaces exhibit no more than about 10-25% surface area macroalgae coverage and no more than about 10-25% surface area invertebrate coverage after being immersed in seawater in a temperature range from about 73.6 deg F. to about 83.1 deg F. for at least 42 days, at least 2 months, at least 3 months, or at least 4 months.

In some cases, the coated underwater surfaces exhibit no more than about 10% surface area macroalgae coverage and no more than about 10% surface area invertebrate coverage after being immersed in seawater in a temperature range from about 73.6 deg F. to about 83.1 deg F. for at least 42 days, at least 2 months, at least 3 months, or at least 4 months.

In some cases, the coated underwater surfaces exhibit no more than about 5% surface area macroalgae coverage and no more than about 5% surface area invertebrate coverage after being immersed in seawater in a temperature range from about 73.6 deg F. to about 83.1 deg F. for at least 42 days at least 2 months, at least 3 months, or at least 4 months.

In some cases, the coated underwater surfaces release a majority of any macroalgae and/or invertebrate coverage through hydrodynamic forces experienced in normal operation of the marine vessel.

In some cases, the coated underwater surfaces release a majority of any macroalgae and/or invertebrate coverage when wiped by hand without removing any coating.

### BRIEF DESCRIPTION OF THE DRAWINGS

FIG. 1 shows a photograph of an antifouling coating Test Sample 1 coated test panel in the Seawater Immersion Assay after 42 days. Test sample 1 exhibited <5% macroalgae coverage and <5% invertebrate coverage after being immersed in seawater for at least 42 days.

FIG. 2 shows a photograph of an antifouling coating Test Sample 2 coated test panel in the Seawater Immersion Assay after 42 days. Test sample 2 exhibited 10-25% macroalgae coverage and <5% invertebrate coverage after being immersed in seawater for at least 42 days.

FIG. 3 shows a photograph of an antifouling coating Test Sample 3 coated test panel in the Seawater Immersion Assay after 42 days. Test sample 3 exhibited Test sample 2 exhibited 10-25% macroalgae coverage and 10-25% invertebrate coverage after being immersed in seawater for at least 42 days.

FIG. 4 shows a photograph of a Comparative coating 1 coated test panel in the Seawater Immersion Assay after 42 days. Comparative sample 1 exhibited 10-25% macroalgae coverage and <5% invertebrate coverage after being immersed in seawater for at least 42 days.

FIG. 5 shows a photograph of a Comparative coating 2 coated test panel in the Seawater Immersion Assay after 42 days. Comparative sample 2 exhibited >25% macroalgae coverage and 10-25% invertebrate coverage after being immersed in seawater for at least 42 days.

FIG. 6A shows photographic results of Seawater Immersion Assay after 4 months for copper-free test formulation panels 1TT, 1P, 1Q, 1YY, 1QQ, 1ZZ, comparative control 2C2 commercial copper-containing paint, and 2C0 blank fiberglass panel negative control. After 4 months in the Seawater Immersion Assay, copper-free test formulation 1ZZ showed minimal fouling comparable to control 2C2 commercial copper-containing paint. Panels coated with formulations 1YY, 1ZZ, 1P and copper-containing control 2C2 exhibited least fouling after 4 months. Panel coated with formulation 1TT exhibited heavy growth after 3 months and was removed from the assay. Panel coated with formulation 1Q exhibited heavy growth after 4 months and was removed from the assay.

FIG. 6B shows photographic results of Seawater Immersion Assay after 8 months for copper-free test formulation panels 1P, and comparative control coatings C1 and C2.

FIG. 6B shows photographic results in Seawater Immersion Assay after 4 months for copper-free test formulation panels 2Q and 2S and negative control 3C0 blank fiberglass panel.

FIG. 7 shows photographic results of Seawater Immersion Assay over 8 months for copper-free test formulation panel 1P, and panels with comparative control coatings C1 and C2.

FIG. 8 shows photographic results in Seawater Immersion Assay after 1 month, 3 months, and 5 months for panels coated with test formulations 1AA, 1BB, 1CC, 1JJ, 1KK, 1LL, and 1TT. After 3 months, heavy growth was exhibited by panels coated with 1AA, 1BB, 1JJ, 1KK, and 1TT formulations and these were removed from the assay.

FIG. 9 shows photographic results in Seawater Immersion Assay after 1 month, 2 months, and 3 months for panels coated with test formulations 1H, 2A, 2B, and 1TT. After 3 months, heavy growth was exhibited by panel coated with 1H formulation and this was removed from the assay.

FIG. 10 shows photographic results in Seawater Immersion Assay after 1 month, 2 months, and 3 months for panels coated with test formulations 2D, 1TT, 2C0 blank fiberglass panel negative control, and comparative control 2C2 commercial copper-containing paint.

FIG. 11 shows photographic results in Seawater Immersion Assay after 1 month and 2 months for panels coated with test formulations 2N, 2O, 2H, 2I, and negative control 3C0 blank fiberglass panel, and comparative control 3C2 commercial copper-containing paint.

FIG. 12 shows results of N. incerta assessment of brown microalgal leachate toxicity after 0 days immersion as a bar graph of fluorescence intensity (RFU) for the test formulations 1TT, 1UU, 1VV, 1WW, 1XX, 1YY, 1ZZ, 2A, 2B, 2C, 2D and control formulations 2C2, T2, PU, 700, 900, 1100SR. G+ is the growth positive control, Tc is Triclosan.

FIG. 13 shows results of N. incerta assessment of brown microalgal leachate toxicity after 28 days immersion as a bar graph of fluorescence intensity (RFU) for the test formulations 1TT, 1UU, 1VV, 1WW, 1XX, 1YY, 1ZZ, 2A, 2B, 2C, 2D and control formulations 2C2, T2, PU, 700, 900, 1100SR. G+ is the growth positive control, Tc is Triclosan.

FIG. 14 shows results of N. incerta assessment of brown microalgal biofilm growth after 48 hours as a bar graph of fluorescence intensity (RFU) for the test formulations 1TT, 1UU, 1VV, 1WW, 1XX, 1YY, 1ZZ, 2A, 2B, 2C, 2D and control formulations 2C2, T2, PU, 700, 900, 1100SR.

FIG. 15 shows results of C. vulgaris assessment of green microalgal leachate toxicity after 0 days immersion as a bar graph of fluorescence intensity (RFU) for the test formulations 1TT, 1UU, 1VV, 1WW, 1XX, 1YY, 1ZZ, 2A, 2B, 2C, 2D and control formulations 2C2, T2, PU, 700, 900, 1100SR. G+ is the growth positive control, Tc is Triclosan.

FIG. 16 shows results of C. vulgaris assessment of green microalgal leachate toxicity after 28 days immersion as a bar graph of fluorescence intensity (RFU) for the test formulations 1TT, 1UU, 1VV, 1WW, 1XX, 1YY, 1ZZ, 2A, 2B, 2C, 2D and control formulations 2C2, T2, PU, 700, 900, 1100SR. G+ is the growth positive control, Tc is Triclosan.

FIG. 17 shows results of C. vulgaris assessment of green microalgal biofilm growth after 48 hours as a bar graph of fluorescence intensity (RFU) for the test formulations 1TT, 1UU, 1VV, 1WW, 1XX, 1YY, 1ZZ, 2A, 2B, 2C, 2D and control formulations 2C2, T2, PU, 700, 900, 1100SR. G+ is the growth positive control, Tc is Triclosan.

FIG. 18 shows results of C. lytica assessment of marine bacterium leachate toxicity after 0 days immersion as a bar graph of solution growth absorbance (600 nm) for the test formulations 1TT, 1UU, 1VV, 1WW, 1XX, 1YY, 1ZZ, 2A, 2B, 2C, 2D and control formulations 2C2, T2, PU, 700, 900, 1100SR. G+ is the growth positive control, Tc is Triclosan.

FIG. 19 shows results of C. lytica assessment of marine bacterium leachate toxicity after 28 days immersion as a bar graph of solution growth absorbance (600 nm) for the test formulations 1TT, 1UU, 1VV, 1WW, 1XX, 1YY, 1ZZ, 2A, 2B, 2C, 2D and control formulations 2C2, T2, PU, 700, 900, 1100SR. G+ is the growth positive control, Tc is Triclosan.

FIG. 20 shows results of C. lytica assessment of marine bacterium leachate toxicity biofilm growth after 0 days as a bar graph of crystal violet absorbance (600 nm) for the test formulations 1TT, 1UU, 1VV, 1WW, 1XX, 1YY, 1ZZ, 2A, 2B, 2C, 2D and control formulations 2C2, T2, PU, 700, 900, 1100SR. G+ is the growth positive control, Tc is Triclosan.

FIG. 21 shows results of C. lytica assessment of marine bacterium leachate toxicity biofilm growth after 28 days as a bar graph of crystal violet absorbance (600 nm) for the test formulations 1TT, 1UU, 1VV, 1WW, 1XX, 1YY, 1ZZ, 2A, 2B, 2C, 2D and control formulations 2C2, T2, PU, 700, 900, 1100SR. G+ is the growth positive control, Tc is Triclosan.

FIG. 22 shows results of C. lytica assessment of marine bacterium biofilm growth after 24 hours as a bar graph of crystal violet absorbance (600 nm) for the test formulations 1TT, 1UU, 1VV, 1WW, 1XX, 1YY, 1ZZ, 2A, 2B, 2C, 2D and control formulations 2C2, T2, PU, 700, 900, 1100SR. G+ is the growth positive control, Tc is Triclosan.

FIG. 23 shows bar graphs of assessment of biofilm growth for formulations 1TT, 1UU, 1VV, comparative copper-containing control 2C2 and 1100SR in N. incerta brown microalgal biofilm growth (left panel, fluorescence intensity (RFU) at 48 hr), C. vulgaris green microalgal biofilm growth (center panel, fluorescence intensity (RFU) at 48 hr), and C. lytica marine bacterium biofilm growth (right panel, crystal violet absorbance (600 nm) at 24 hr) biological assays.

FIG. 24 shows bar graphs of assessment of biofilm growth for formulations 1TT, 1WW, 1XX, comparative copper-containing control 2C2 and 1100SR in N. incerta brown microalgal biofilm growth (left panel, fluorescence intensity (RFU) at 48 hr), C. vulgaris green microalgal biofilm growth (center panel, fluorescence intensity (RFU) at 48 hr), and C. lytica marine bacterium biofilm growth (right panel, crystal violet absorbance (600 nm) at 24 hr) biological assays.

FIG. 25 shows bar graphs of assessment of biofilm growth for formulations 1WW, 1YY, 1ZZ, comparative copper-containing control 2C2 and 1100SR in N. incerta brown microalgal biofilm growth (left panel, fluorescence intensity (RFU) at 48 hr), C. vulgaris green microalgal biofilm growth (center panel, fluorescence intensity (RFU) at 48 hr), and C. lytica marine bacterium biofilm growth (right panel, crystal violet absorbance (600 nm) at 24 hr) biological assays.

FIG. 26 shows bar graphs of assessment of biofilm growth for formulations 1TT, 2A, 2B, comparative copper-containing control 2C2 and 1100SR in N. incerta brown microalgal biofilm growth (left panel, fluorescence intensity (RFU) at 48 hr), C. vulgaris green microalgal biofilm growth (center panel, fluorescence intensity (RFU) at 48 hr), and C. lytica marine bacterium biofilm growth (right panel, crystal violet absorbance (600 nm) at 24 hr) biological assays.

FIG. 27 shows bar graphs of assessment of biofilm growth for formulations 1TT, 2C, 2D, comparative copper-containing control 2C2 and 1100SR in N. incerta brown microalgal biofilm growth (left panel, fluorescence intensity (RFU) at 48 hr), C. vulgaris green microalgal biofilm growth (center panel, fluorescence intensity (RFU) at 48 hr), and C. lytica marine bacterium biofilm growth (right panel, crystal violet absorbance (600 nm) at 24 hr) biological assays.

### DETAILED DESCRIPTION OF THE INVENTION

Antifouling coating compositions and paints that decrease hull fouling without copper or tri-organotin derivatives are provided.

An antifouling coating composition is provided comprising a brominated epoxy resin and a brominated additive. In some cases, the antifouling coating composition further includes a surface additive. In some cases, the antifouling coating composition includes an antifouling agent. The antifouling coating composition is suitable for coating or painting the hull of marine vessels or freshwater vessels. The antifouling coating composition may be used in a method of reducing fouling of the underwater surface of freshwater and marine vessels.

Many strains of marine algae and seaweeds produce brominated metabolites that can inhibit bacterial growth. “Bromine compounds: Chemistry and Applications,” D. Price, B. Iddon, and B. J. Wakefield, eds., Elsevier Science Publishers B.V., 1988, Ch. 2, Brominated marine natural products, pp. 121-144.

Brominated metabolites can be responsible for seaweed autotoxicity and allelopathic effects. Sudatti et al., 2020, New ecological role of seaweed secondary metabolites as autotoxic and allelopathic, Frontiers Plant Sci. Vol. 11, Article 347. Allelopathy is the chemical inhibition of one organism by another due to release into the environment of substances acting as growth inhibitors.

It has been discovered that a composition comprising a combination of brominated epoxy resins, brominated additives, and surface additives effectively retards the growth of fouling organisms on submerged surfaces under marine conditions. Addition of one or more antifouling agents further improves the antifouling characteristics of the composition.

CN110294992A discloses a corrosion resistant and high-temperature resistant marine coating including a phenolic resin, polyurethane, silicon dioxide, titanium dioxide, polyphenylene sulfide fiber, brominated epoxy resin, triethyl acetocitrate, polyaniline, zinc oxide, aluminum tripolyphosphate, polytetrafluoroethylene, copper oxide, and ceramic fiber.

CN102352171 B discloses a coating with marine environment corrosion resistance. The coating includes: a main agent comprising low-viscosity solvent-free epoxy resin, activated thinner, organic solvent, a filler, a thixotropic agent, and a curing agent comprising amine resin, an activated thinner, an auxiliary agent, and an organic solvent.

KR10-1643653 B1 discloses a watercraft water-soluble epoxy ester-modified vinyl resin composition imparted with flame retardant performance, comprising an epoxy ester resin; a vinyl monomer; a volatile organic compound; a phosphate ester compound; and the balance water, wherein the epoxy ester resin is prepared through an esterification reaction of an epoxy resin and a fatty acid having an unsaturated bond in the molecule, wherein the epoxy resin is a brominated epoxy resin alone or a mixture of brominated epoxy resin and bisphenol a type epoxy resin.

When investigated alone, brominated epoxy resins did not impart desired level of antifouling characteristics.

### Definitions

The singular forms “a”, “an” and “the” are intended to include the plural forms as well, unless the context clearly indicates otherwise.

The term “and/or” refers to and encompasses any and all possible combinations of one or more of the associated listed items.

The term “about,” when referring to a measurable value such as an amount of a compound, dose, time, temperature, and the like, is meant to encompass variations of +/−10%, 5%, 1%, 0.5%, or even 0.1% of the specified amount.

The terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise defined, all terms, including technical and scientific terms used in the description, have the same meaning as commonly understood by one of ordinary skill in the art to which this disclosure belongs. In the event of conflicting terminology, the present specification is controlling.

All patents, patent applications, and publications referred to herein are incorporated by reference in their entirety.

The term “fouling” refers to the accumulation of marine growth on a ship's underwater surfaces. For example, the term “hull fouling” refers to accumulation of marine growth on a ship's hull. The buildup of organisms on the hull can cause the vessel to lose fuel efficiency, transfer invasive species, and promote corrosion damage on the hull leading to increased operating costs.

The term “antifouling agent” refers to a compound that when added a coating or paint composition reduces growth of organisms on the painted or coated surface.

The term “non-persistent antifouling agent” refers to an antifouling agent that is capable of degrading in the environment to non-toxic degradants.

The term “surface additive” refers to an additive that when added to a coating composition or paint reduces the surface energy of coated or painted surfaces. The surface additive may be a low surface energy additive. The surface additive may be a silicone surface additive. The surface additive may be a polydimethylsiloxane additive.

The term “corrosion” refers to chemical destruction of any solid material. Corrosion is often associated with biological and physical decay of materials. Corrosion increases rough surfaces and convert hard metal into a friable corrosion product. An increase in temperature can accelerate corrosion. Sudden changes in temperature may cause layers of corrosion product to burst and fall off due to differences in thermal coefficients of expansion. “Erosion” removes solid corrosion products that may help protect the material from further deterioration. In the sea corrosion is accelerated by biological factors such as the influence of microorganisms and metabolism products of living beings. Ivce et al., Protective coatings for the underwater part of a ship's hull, Pomorski zbornik 55 (2018), 59-70.

The term “ablative coating” or “self-polishing coating” also known as sloughing bottom paint refers to a type of paint designed to ablate or wear off slowly, for example, in order to expose a fresh layer of biocides. Scrubbing a hull with ablative coating releases its biocides into the environment. A non-ablative coating is a hard bottom coating that does not wear off on purpose, but still releases most fouling under normal hydrodynamic conditions when the vessel is moving and or in currents.

The term “ambient temperature” refers to the average temperature of the environment. The term “ambient room temperature” refers to about 20 deg C. (68 deg F.).

The term “epoxy resin” is a generic name for compounds that have two or more oxirane rings (epoxy groups) in one molecule and are optionally cured three-dimensionally by a suitable curing agent (also called hardener). In many cases the term refers to bisphenol A diglycidyl ester (DGEBA) which is formed by the reaction of bisphenol A and epichlorohydrin. Major types of epoxy resins include bisphenol A type, bisphenol F type characterized by having low viscosity, and bisphenol A D type having intermediate characteristics between those of DGEBA and bisphenol F types.

Epoxy resins may be supplied as liquids or solids which can be used in castings, coatings, tooling, potting, adhesives, or reinforces applications.

Brominated epoxy resins may also be supplied as epoxy resin dissolved in a suitable solvent such as toluene or acetone. These brominated epoxy resins are primarily used to coat printed circuit boards.

The addition of curing agents (also known as hardeners) to epoxy resins in the proper proportions causes these resins to polymerize into infusible products. The properties of these products can be modified by addition of certain fillers, reinforcements, extenders, plasticizers, thixotropic agents, etc. The epoxy resins can be characterized by viscosity, Mettler softening point, and color.

One part epoxy resins, also known as single part epoxies, or heat cured epoxies) contain latent curing agents. Latent curing agents are mixed into the epoxy resin and have limited reactivity at ambient temperature. They react at elevated temperature, light, moisture, or pressure to cure the epoxy resin.

Latent curing agents include heat activated, light (UV) activated, moisture activated, and pressure activated curing agents or hardeners. Heat activated curing agents include Lewis-acid complexes (amine complexes of boron trifluoride, BF3) dicyanamides, modified imidazoles, organic acids, hydrazides, amine-imide compounds and molecular sieves. Light (UV) activated curing agents include aromatic diazonium salts, diallyl iodonium salts, triaryl sulfonium salts. Moisture activated curing agents may include ketoimines, and molecular sieves. Dicyanamides are crystals with a high melting point of 207-210 deg C. When dispersed in epoxy resin in the form of fine powder dicyanamides will have a pot life of 6-12 months and will remain stable for a greater amount of time than imidazole. Typically, 4-10 parts of curing agents may be added to 100 parts by weight epoxy resin such as a DGEBA. In many cases an accelerator can be added to decrease curing temperatures. Accelerators such as dimethyl urea can be added to dicyandiamide and epoxy resin.

One part epoxy systems may be available as liquid, paste, and solid forms. One part epoxy resins can be formulated to cure at lower temperatures for greater flexibility and impact resistance. Two-part epoxy resins have similar environmental resistance but involve two components which cure upon mixing rather than thermally.

The term “brominated epoxy resin” refers to an epoxy resin comprising one or more, or two or more bromine substituents.

Brominated epoxy resins may be tested under ASTM D1763 requirements.

The “epoxide equivalent weight” (EEW) refers to the number of grams of epoxy resin required to give 1 mole of epoxide groups. The EEW may be determined by titration. The EEW standard test method for epoxy content of epoxy resins is ASTM D1652. Weight per Epoxy Equivalent (WPE) may be determined using ASTM D1652 test method.

Viscosity may be tested using ASTM D445 test method. Alternatively, viscosity (cps) of the brominated epoxy resin may be determined by the Garner-Holdt method, for example, at 40% in butyl carbinol at 25 deg C. The Gardner-Holdt bubble tube method may be determined by adding a quantity of resin or vehicle to a predetermined height and sealing to a specified level, leaving a bubble of air. The tube is inverted and the air bubble is then timed from one end of the tube to the other (or from one line to another) at a prespecified temperature. Air bubble time may be compared to standardized tubes.

Color may be tested using ASTM D1544 test method using a 40% solids solution in butyl carbitol or low color using ASTM D1209 test method (Type I and Type III resins).

Softening point may be determined using ASTM D3104 test method.

The embodiments described in one aspect of the present disclosure are not limited to the aspect described. The embodiments may also be applied to a different aspect of the disclosure as long as the embodiments do not prevent these aspects of the disclosure from operating for its intended purpose.

### Compositions

An antifouling coating composition is provided comprising a brominated epoxy resin, a brominated additive, a surface additive, and an antifouling agent. The antifouling coating composition may be used for coating or painting the hull of marine or freshwater vessels. The antifouling coating composition may be used in a method of reducing fouling of the surface of freshwater and marine vessels. In some cases, representative antifouling composition comprises the materials shown in Table 1.

TABLE 1
Representative Antifouling Coating Compositions

| | Amount | Amount | Amount | Amount | Amount | Amount |
|---|---|---|---|---|---|---|
| Material | (wt %) | (wt %) | (wt %) | (wt %) | (pph) | (pph) |
| Brominated | 60-95 | 60-90 | 60-90 | 60-90 | 100 | 100 |
| Epoxy Resin | | | | | | |
| Brominated | 0-20 | 0-20 | 0.1-20 | 0.1-20 | 0-17 | 4-14 |
| additive | | | | | | |
| Surface | 0-20 | 0.1-20 | 0-20 | 0.1-20 | 0-20 | 1-15 |
| additive | | | | | | |
| Antifouling | 0.1-20 | 0.5-15 | 0.5-15 | 0.5-15 | 0.2-30 | 1-20 |
| agents | | | | | | |

In some cases, the brominated epoxy resin is a solvent based brominated epoxy resin in a suitable solvent. In some cases, the brominated additive is a reactive brominated additive. In some cases, the brominated additive is a nonreactive brominated additive. In some cases, the surface additive is a polydimethylsiloxane additive. In some cases, the polydimethylsiloxane additive is an epoxy-functional polydimethylsiloxane. In some cases, the polydimethylsiloxane additive is a polyester-modified, hydroxy-functional polydimethylsiloxane. In some cases, the polydimethylsiloxane additive is a combination of an epoxy-functional polydimethylsiloxane and a polyester-modified, hydroxy-functional polydimethylsiloxane. In some cases, the antifouling agent includes a non-metallic antifouling agent. In some cases, the antifouling agent comprises tralopyril. In some cases, the antifouling agent comprises zinc pyrithione or zinc omadine. In some cases, the antifouling agent comprises tralopyril, zinc pyrithione and zinc omadine.

In some cases, the antifouling coating is a non-ablative coating or a hard bottom paint that does not wear off on purpose, but still releases any fouling under normal hydrodynamic conditions when the vessel is moving and or with currents.

In some cases, the antifouling coating is an ablative coating or self-polishing coating that wears off on purpose, and releases biocides to reduce fouling. In some cases, seawater-soluble pigments such as zinc oxide dissolve near the surface of the coating. The continuous removal of such soluble pigments creates voids in the uppermost paint layer. Seawater diffuses into resultant porous polymer matrix and biocidal compounds are exposed and dispersed into coating.

### Brominated Epoxy Resins

Antifouling coating compositions provided herein include one or more brominated epoxy resins. Any appropriate brominated epoxy resin may be employed. In some cases, the brominated epoxy resin is a solvent based brominated epoxy resin in a suitable solvent or a solid type brominated epoxy resin.

In some cases, the brominated epoxy resin is a solid epoxy resin of the tetrabromobisphenol-A epichlorohydrin type. In some cases, the brominated epoxy resin is a reaction product of tetrabromobisphenol A and epichlorohydrin. In some cases, the brominated epoxy resin is commercially available.

In some cases, the brominated epoxy resin is a liquid type brominated epoxy resin, e.g., supplied in a liquid form from the manufacturer. The liquid type brominated epoxy resin comprises a solid epoxy resin in a solvent. In some cases, the liquid type brominated epoxy comprises a solid content (%) in a range of from about 40 to about 90%, about 50 to about 85%, about 50 to about 81%, or about 59.5 to about 81% solids by weight in a solvent. In some cases, the liquid type brominated epoxy comprises a solid content (%) in a range of 59.5-61.0 wt %, 64-66 wt %, or 79-81 wt % solids in a solvent. In some cases, the liquid type brominated epoxy resin may have EEW (g/eq) in a range of 390-445, 390-410, 425-440, or 425-445 by ASTM D-1652. In some cases, the liquid type brominated epoxy resin may have bromine content in a range of 10-25, 18-22, 19.5-21.5, or 18-21 wt %, calculated. In some cases, the liquid type brominated epoxy resin may have a viscosity at 25 deg C. in a range of 10-2500, 14-20, 1200-2000, or 1500-2500 mPa·s by ASTM D-445.

In some cases, the brominated epoxy resin is a solid type brominated epoxy reason. In some cases, the solid type brominated epoxy resin may be dissolved in a solvent. In some cases, the solid type brominated epoxy resin may have EEW (g/eq) in a range of 305-410, 305-355, or 380-410 by ASTM D-1652. In some cases, the liquid type brominated epoxy resin may have bromine content in a range of 40-55 wt %, or 46-51%, calculated.

In some cases, the brominated epoxy resin may be made from a composition comprising epichlorohydrin and tetrabromobisphenol A (TBBA), and or its diglycidyl ether, 2,2-bis[3,5-dibromo-4-(2,3-epoxypropoxy)phenyl]propane. In some cases, the brominated epoxy resin can be made from a composition comprising the brominated epoxy resin may be made from a composition comprising epichlorohydrin tetrabromobisphenol A, bisphenol A, and epichlorohydrin.

The brominated epoxy resin may be a brominated epoxy resin in an appropriate solvent. In some cases, the brominated epoxy resin has 50-90 wt %, 55-85 wt %, or 60-85 wt % solid content in a solvent. The solvent may be an organic solvent. The solvent may be, for example, acetone, toluene, dimethylacetamide, methyl ethyl ketone, xylene, aromatic hydrocarbon solvent oil (S-100), n-butanol, isobutanol, ethanol, cyclohexanone, or diacetone alcohol, or a combination thereof. In some cases, the solvent may be one or more of acetone, dimethylacetamide, or toluene. In some cases, the solvent may be present in the brominated epoxy resin in a range from 0-50 wt %, 0-45 wt %, 10-45 wt %, or 15-25 wt %. In some cases, the brominated epoxy resins is a brominated bisphenol A epoxy resin supplied as 80% solids by weight solution in acetone. In some cases, the brominated epoxy resins is a brominated bisphenol A epoxy resin supplied as 65% solids by weight solution in toluene.

Brominated epoxy resins are commercially available. The brominated epoxy resin may be a commercially available solvent based brominated epoxy resin. The brominated epoxy resin may be a BEB or BET liquid type brominated epoxy resin from Chang Chun Plastics Co., Ltd., Taiwan. For example, the brominated epoxy resin may be a BEB400T65, BEB400T60, BEB530A80, BEB530A80, BET534A80, BET535A80, BET540A80, or BET550A80 liquid type brominated epoxy resin. In some cases, the liquid type brominated epoxy resin is 64-66 wt % solids in toluene or about 80 wt % in acetone.

The brominated epoxy resin may be a DER™ brominated epoxy resin from Dow Chemical Company. For example, the brominated epoxy resin may be DER™ 530-A80 brominated epoxy resin in acetone, DER™ 538-A80 brominated epoxy resin in acetone, DER™ 542 solid epoxy resin of the tetrabromo bisphenol A epichlorohydrin type, DER™ 560 solid brominated epoxy resin, DER™ 592-A80, or DER™ 593 brominated epoxy resin in DOWANOL™ PM glycol ether. In some cases, the brominated epoxy resin is commercially available, e.g., as EPON™ resin 1124-A-80, Westlake Chemical Corporation. In some cases, the brominated epoxy resin is D.E.R.™ 542, Olin Corporation; for example, D.E.R. 542 50% solids by weight dissolved in 60/40 (v:v) toluene/dimethylacetamide or D.E.R. 542 50% solids by weight dissolved in toluene, and the like.

The brominated epoxy resin may be a liquid brominated epoxy resin in any appropriate solvent. In some cases, the brominated epoxy resin may be a liquid brominated epoxy resin in acetone, toluene, or a glycol ether. In some cases, the brominated epoxy resin may be of the tetrabromo bisphenol A epichlorohydrin type. In some cases, the brominated epoxy resin may be of the diglycidyl ether type. In some cases, the brominated epoxy resin may be a solid brominated epoxy resin. The brominated epoxy resin may have an EEW on solids (g/eq) in a range of between 100-10,000, 200-5,000, 300-1,000, 305-470, 390-410, 425-445, 425-440, 465-495, 305-355, 440-470, or 350-370 by ASTM D-1652. In some cases, the brominated epoxy resin may have an epoxide equivalent weight (EEW) in a range of 305-450 g/eq by ASTM D1652. In some cases, the brominated epoxy resin comprises an EEW in a range of 305-355 g/eq, 380-420 g/eq, 380-310 g/eq, 390-410 g/eq, 424-445 g/eq, 420-450 g/eq, 425-445 g/eq, 420-450 g/eq, 425-445 g/eq, 395-425 g/eq, or 425-440 g/eq. In some cases, the brominated epoxy resin has a bromine content or bromine content on resin solids (%) in a range of 18-66 wt %, 18-21 wt %, 19.5-21.5 wt %, 46-51 wt %, 46-50 wt %, 64-66 wt %, or about 50 wt % Br, calculated.

The viscosity of the brominated epoxy resin may be 14.0-20.0, 1100-1900 cps (25 deg C.) by Garner Holdt method 40% in butyl carbinol. In some cases, the brominated epoxy resin is a solvent based brominated epoxy resin. In some cases, the solvent based brominated epoxy resin may have one or more of an EEW in a range of 390-410 g/eq, a viscosity at 25 deg C. of 14-20 cps, and have a solids content of 64-66 wt % in toluene. In some cases, the solvent based brominated epoxy resin may have one or more of an EEW in a range of 425-445 g/eq, a viscosity at 25 deg C. in a range of 1100-1900 cps, and have a solids content of 79-81 wt % in acetone. The unfilled antifouling composition may include the brominated epoxy resin at 60-95 wt % or 70-90 wt %.

The brominated epoxy resins may also include one or more additional additives such as a solvent, a curing agent, an accelerator, a plasticizer, a diluent, a defoaming agent, a wetting agent, an adhesion promoter, a dispersing agent, a thixotropic agent, a drying agent, a filler, a pigment, a coloring agent, and/or other ingredients commonly used in paints.

The curing agents can react with epoxy groups to form a three-dimensional network structure by crosslinking. The curing agent (also known as a hardener) may be selected from the group consisting of amines, amine resin, aminosilanes, acids, acid anhydrides, phenols, alcohols, dicyanamides, and thiols. The amine resin may comprise one or more of: aliphatic polyamine curing agent, aliphatic amine adduct curing agent, amidoamine curing agent, amino polyamide resin curing agent, cycloaliphatic amine curing agent, aromatic amine curing agent, araliphatic amine curing agent or ketimine curing agent. The curing agent may be, for example, a dicyanamide curing agent. The curing agent can be an aminosilane curing agent (e.g., curing agent RSC-4628, Westlake Epoxy). The curing agent may be present in the brominated epoxy resin in a range of from 0-4, 0.1-4, or 2-3 parts solid compared to 100 parts solid of the brominated epoxy resin.

An accelerator can be added to the composition to decrease curing temperatures. The accelerator may be a tertiary amine, dimethylurea, carboxylic acid, imidazoles, and alcohols. For example, an accelerator such as 2-methylimidazole or dimethyl urea can be added to a composition comprising a brominated epoxy resin and dicyandiamide curing agent. In some cases, the accelerator may be a 2-methylimidazole accelerator. The accelerator may be present in from 0 to 0.2, 0.001-0.1, or 0.01-0.1 parts solid compared to 100 parts solid of the brominated epoxy resin.

Diluents can be used to reduce viscosity and improve flowability and permeability. The diluent may be a reactive diluent having an epoxy group or a non-reactive diluent having no epoxy group. The active diluent may comprise one or more of the following components: cresyl glycidyl ether, phenyl glycidyl ether, butyl glycidyl ether, allyl glycidyl ether, isooctyl glycidyl ether, p-tert-butylbenzene glycidyl ether, neopentyl glycol diglycidyl ether, 1, 4-butanediol diglycidyl ether, glycidyl versatate, or a commercially available hydrocarbon petroleum resin. The optional active diluent may be present in the coating composition in 0-15, 1-15, or 5-10 wt %.

Fillers can be used to increase weight and decrease costs and improve mechanical strength of the cured composition. The filler may comprise one or more of the following components: talc, precipitated barium sulfate, sericite, kaolin or potash feldspar powder, glass fiber powder, ceramic fiber powder, hollow glass bead powder, hollow ceramic bead powder, PE wax powder. The optional filler may be present in the coating composition in 0-50 pph, 10-45 pph, or 20-30 pph.

Thixotropic agents may be used to control rheology, flowability and increase viscosity. The thixotropic agent may be any appropriate thixotropic agent. In some cases, the thixotropic agent is a rheology modifying agent. In some cases, the thixotropic agent may be selected from one or more of organobentonite, fumed silica, hydrogenated castor oil, or microgel. In some cases, the rheology modifying filler is a fumed silica. In some cases, the thixotropic agent is commercially available, e.g., AEROSIL 200 hydrophilic fumed silica, EVONIK Industries AG. The optional thixotropic agent may be present in the coating composition in 0-5 pph, or 0.5-5 pph.

Dispersing agents may include a dispersing agent. The dispersing agent can be added to stabilize the pigment and filler particle dispersion in the composition, for example, to prevent flocculation of the pigments. In some cases, the dispersing agent is a DISPERBYK dispersant, BYK USA, Inc. In some cases, the dispersing agent is a tin free dispersing agent. In some cases, the dispersing agent is a polyglycol-polyester-modified polyalkyleneimine, an alkylammonium salt of a polycarboxylic acid polymer, or higher molecular weight polyester. Commercially available dispersing agents are available. The dispersing agent can be a polyglycol-polyester-modified polyalkyleneimine, tin free, such as for example, DISPERBYK-2152 TF, or a polyester, tin free, such as for example, DISPERBYK-2151 TF, BYK Chemie GmbH, Germany. The dispersing agent may be present in the composition from 0-10 wt %, 0.1-10 wt %, 1-8 wt %, or 2-7 wt %.

Surfactants may be added to the brominated epoxy resin compositions, for example, to stabilize the composition, as a wetting, and/or defoaming agent. Any appropriate surfactant may be employed. In some cases, the surfactant is a nonionic surfactant. In some cases, the surfactant may be Surfynol® surfactant. In some cases, the surfactant is Surfynol® 420 (EVONIK). In some cases, the surfactant may be present in the composition from 0-3 wt %, 0.1-2 wt %, 0.1-1.5 wt %, or 0.5-1.0 wt %.

In some cases, the antifouling coating composition may include an additional epoxy resin. The additional epoxy resin may comprise one or more of bisphenol A epoxy resin, bisphenol F epoxy resin, novolac epoxy resin, aliphatic epoxy resin, or novolak epoxy resin. The weight ratio of brominated epoxy resin to additional epoxy resin may be in a range of 100:0-50:50, 90:10-60:40, or 80:20-70:30.

### Brominated Additives

Antifouling coating compositions provided herein include one or more brominated additives. Brominated additives are organobromine compounds that have an inhibitory effect on combustion chemistry and tend to reduce the flammability of products containing them. In some cases, the brominated additive may be a brominated flame retardant. In some cases, the brominated additives can be brominated additives that are used in the electronics industry to reduce flammability of printed circuit boards, connectors, plastic covers, electrical cables. The brominated additives may be small molecule brominated additives having a molecular weight of no more than about 1500 g/mol, or no more than 1,000 g/mol. The brominated additives may have a wt % Br of from 50-95 wt % Br, or 55-80 wt % Br.

The brominated additive may be an organic brominated additive. The brominated additive may be a reactive brominated additive or a nonreactive brominated additive. The brominated additive may have 50-95 wt % Br, or 55-80 wt % Br. A number of representative brominated additives are described in “Bromine compounds: Chemistry and Applications,” D. Price, B. Iddon, and B.J. Wakefield, eds., Elsevier Science Publishers B.V., 1988, Ch. 9, pp. 301-331. Reactive brominated additives are shown in Table 2.

TABLE 2
Reactive Brominated Additives

| | |
|---|---|
| M.W. (g/mol) | Wt % Br |

Aliphatic

| | | |
|---|---|---|
| Bromoform | 253 | 94.9 |
| Vinyl bromide | 107 | 74.8 |
| Ethylene bromohydrin | 125 | 64.0 |
| Dibromoneopentyl glycol | 262 | 61.1 |

Aromatic

| | | |
|---|---|---|
| Tribromophenol | 331 | 72.5 |
| Pentabromophenol | 409 | 78.2 |
| Dibromostyrene | 262 | 61.1 |
| Tetrabromophthalic | 440 | 72.7 |
| anhydride | | |
| Tetrabromobisphenol A | 544 | 58.8 |

The antifouling coating composition may include one or more reactive brominated additives. Reactive additives comprise a reactive group that can enter into polymerization reactions. The reactive brominated additive may be an aliphatic reactive brominated additive or an aromatic reactive brominated additive. The aliphatic reactive brominated additive may be selected from Bromoform, Vinyl bromide, Ethylene bromohydrin, Dibromoneopentyl glycol, and the like.

The reactive brominated additive may be an aromatic reactive brominated additive. The aromatic reactive brominated additive may be selected from Tetrabromobisphenol A, Tetrabromophthalic anhydride, Dibromostyrene, Pentabromophenol, Tribromophenol, and the like.

The antifouling coating composition may include one or more nonreactive brominated additives. Nonreactive brominated additives may be added to the composition but do not polymerize with the brominated epoxy resin. They are typically blended until homogenous with the resin, but may bloom to the surface of the polymer. Representative nonreactive brominated additives are shown in Table 3.

TABLE 3
Nonreactive Brominated Additives

| | |
|---|---|
| M.W. (g/mol) | Wt % Br |

Aliphatic

| | | |
|---|---|---|
| Tetrabromoethylene | 344 | 93.0 |
| 1,1,2,2-tetrabromoethane | 346 | 92.5 |
| Pentabromoethane | 374 | 85.6 |
| 1,2,3,4-tetrabromobutane | 402 | 79.6 |
| Tetrabromo-2,3-dimethylbutane | 425 | 94.1 |
| Octabromohexadecane | 858 | 74.6 |

Cycloaliphatic

| | | |
|---|---|---|
| Hexabromocyclohexane | 558 | 86.0 |
| Dibromocyclododecene | 324 | 49.4 |
| Dibromocyclododecane | 326 | 49.1 |
| Tribromocyclododecane | 405 | 59.3 |
| Tetrabromocyclododecene | 482 | 66.4 |
| Hexabromocyclododecane | 642 | 74.8 |

Aromatic

| | | |
|---|---|---|
| Hexabromobenzene | 552 | 88.8 |
| Pentabromotoluene | 487 | 82.1 |
| 1,2-dibromoethylbenzene | 264 | 60.6 |
| Pentabromoethylbenzene | 501 | 79.8 |
| Pentabromophenyl ethyl ether | 505 | 79.2 |
| Pentabromophenyl allyl ether | 517 | 77.4 |
| Octabromobiphenyl ether | 802 | 79.8 |
| Decabromobiphenyl | 944 | 84.7 |
| Decabromobiphenyl ether | 960 | 83.3 |
| 1,2-bis (2,4,6-tribromophenoxy) | 664 | 72.3 |
| ethane | | |
| Tetradecabromodiphenoxybenzene | 1368 | 81.9 |

The nonreactive brominated additives may be aliphatic nonreactive brominated additives. In some cases, the aliphatic nonreactive brominated additives may be selected from Tetrabromoethylene, 1,1,2,2-tetrabromoethane, Pentabromoethane, 1,2,3,4-tetrabromobutane, Tetrabromo-2,3-dimethylbutane, Octabromohexadecane, and the like.

The nonreactive brominated additives may be cycloaliphatic nonreactive brominated additives. In some cases, the cycloaliphatic nonreactive brominated additives may be selected from Hexabromocyclohexane, Dibromocyclododecene, Dibromocyclododecane, Tribromocyclododecane, Tetrabromocyclododecene, Hexabromocyclododecane, and the like.

The nonreactive brominated additives may be aromatic nonreactive brominated additives. In some cases, the aromatic nonreactive brominated additives may be selected from Hexabromobenzene, Pentabromotoluene, 1,2-dibromoethylbenzene, Pentabromoethylbenzene, Pentabromophenyl ethyl ether, Pentabromophenyl allyl ether, Octabromobiphenyl ether, Decabromobiphenyl, Decabromobiphenyl ether, 1,2-bis (2,4,6-tribromophenoxy) ethane, Tetradecabromodiphenoxybenzene, and the like.

In some cases, the brominated additives may include, but are not limited to, tetrabromobisphenol A (TBBA), polybrominated biphenyl ethers (PBDEs), polybrominated biphenyl (PBB), brominated cyclohydrocarbons, polybrominated diphenyl oxides, decabromodiphenyl oxide, tris(3-bromo-2,2-bis(bromomethyl)propyl) phosphate, tris(tribromoneopentyl) phosphate, tetrabromophthalic acid, 1,2-bis(tribromophenoxy)ethane, hexabromocyclododecane, dibromoneopentyl glycol, brominated diphenylethane, 1,3,5-tris(2,3-dibromopropyl) isocyanurate, ethylenebis(tetrabromophthalimide), tris(tribromoneopentyl) alcohol, polypentabromobenzyl acrylate, bromoform, vinyl bromide, ethylene bromohydrin, tribromophenol, pentabromophenol, dibromostyrene, and tetrabromophthalic anhydride. In some cases, the brominated additive may be 3,3′,5,5′-tetrabromobisphenol A (TBBA). TBBA is typically used in printed circuit boards as a reactive component. Because it is chemically bonded to the resin of the printed circuit, it is less easily released than other additives loosely applied in foams and poses less risk to human health in an EU risk assessment. In some cases, the antifouling coating composition comprises one or more brominated additives in a concentration within a range of 0.5-10 wt %, 1-10 wt %, or 5-10 wt %.

### Surface Modifying Additives

The antifouling coating composition may include one or more surface modifying additives, also known as surface additives. The surface additives may be added to the antifouling coating composition or paint to decrease the surface energy of coated or painted surfaces. The surface additives can help provide a slippery easily cleaned surface. The surface additives may be silicone surface additives. The surface additives may include one or more functional polydimethylsiloxane additives and/or hydrophilic modified polysiloxanes. The surface additive may comprise a functional polydimethylsiloxane or hydrophilic polysiloxane to improve surface wetting, surface slip, and water resistance of epoxy resin systems. A functional polydimethylsiloxane comprises one or more reactive groups that are reactive with epoxy resins. Reactive moieties on the functional surface additives available for epoxy reactions can include glycidyl and cycloaliphatic epoxy groups, and hydroxyl groups. Amino functional siloxanes can be substituted for the amine functional epoxy hardeners. Functional silicones such as functional polydimethylsiloxanes are commercially available from, for example, Gelest, Inc., Morristown, PA; Altana AG, Wesel, Germany; or Siltech Corporation, East York, Ontario, Canada.

Epoxy functional silicones can include epoxy-functional siloxanes, epoxy type-bisphenol, epoxy type-polyglycol, epoxy-type cycloaliphatic, epoxypropoxypropyl-terminated siloxanes, multifunctional siloxanes, epoxy-functional macromers, and cycloaliphatic epoxy silicones. For example, epoxypropoxypropyl-terminated siloxanes may include epoxypropoxypropyl-terminated polydimethylsiloxanes, and (epoxypropoxypropyl) dimethoxysilyl-terminated polydimethylsiloxanes. The epoxy-functional polydimethylsiloxane may be, for example, commercially available as BYK-Silclean 3701 (Altana). Hydroxy-functional silicones may include hydroxy-functional siloxanes such as carbinol-functional siloxanes comprising a hydroxy functional group bound to a carbon (C—OH) or silanol-functional siloxanes comprising a hydroxy group bound to a silicone (Si—OH). Hydroxy-functional silicones may include carbinol-terminated polydimethylsiloxanes, ABA-caprolactone-dimethylsiloxane-caprolactone block copolymers, bis (hydroxyethyl)amine-terminated polydimethylsiloxanes, (2-hydroxy-3-methoxypropoxy)propyl-terminated polydimethylsiloxanes, carbinol-functional methylsiloxane-dimethylsiloxane copolymers, carbinol-functional macromers, and carbinol-functional polydimethylsiloxanes.

The surface additive may include a hydrophilic polysiloxane such as a polyester-modified, hydroxy-functional polydimethylsiloxane. A polyester-modified, hydroxy-functional polydimethylsiloxane may be included to promote surface adhesion to the substrate. The hydroxy functional polydimethyl siloxane may be a polyester-modified, hydroxy-functional polydimethylsiloxane may be, for example, BYK-370 (Altana). Other hydrophilic modified polysiloxanes can include di-, tri-, or graft-copolymers with common hydrophilic groups such as polyethylene oxide/polypropylene oxide. Some examples of commercially available additives include polyether siloxane copolymer (e.g., TEGO Glide 410, Evonik), polyether modified surface modifier (KP-126, Shin-Etsu), and polyether modified polysiloxane (e.g., Efka SL 3257,BASF).

Amine-functional silicones can include amine-terminated polydimethyl siloxanes, such as, for example, aminopropyl-teminated polydimethylsiloxanes, N-ethylaminoisobutyl-terminated polydimethylsiloxanes, and amine-functional copolymers such as, for example, aminoethylaminopropylmethylsiloxane-dimethylsiloxane copolymers and amine-functional siloxanes with alkoxygroups.

The surface additives may include functionalized polydimethylsiloxanes. The polydimethylsiloxane additives may include an epoxy-functional polydimethylsiloxane. The epoxy-functional polydimethylsiloxane may be, for example, commercially available as BYK-Silclean 3701 (Altana). The epoxy-functional polydimethylsiloxane has an epoxy functional group and can cross-link permanently by forming covalent bonds with the epoxy resin system. This increases the hydrophobic and oleophobic properties, which reduces adhesion of contaminants and organisms and improves cleanability. The antifouling coating composition may include an epoxy-functional polydimethylsiloxane concentration within a range of from 0-20 wt %, 0.1-20 wt %, 0.1-10 wt %, or 0.5-5 wt %.

In some cases, the polyester-modified, hydroxy-functional polydimethylsiloxane may be present in the antifouling coating composition at 0-5 wt %, 0.1-2 wt %, or 0.12-1 wt %. In some cases, the antifouling coating composition includes an epoxy-functional polydimethylsiloxane and a polyester-modified, hydroxy-functional polydimethylsiloxane. The one or more surface additives may be used in the antifouling coating composition in a total concentration within a range of from 0-20 wt %, 0.1-20 wt %, 0.1-6 wt %, or 0.05-3 wt %.

### Antifouling Agents

The antifouling coating composition may include one or more antifouling agents. The one or more antifouling agents may include any appropriate antifouling agent. In some cases, the antifouling agent does not include a copper antifouling agent. In some cases, the antifouling agent does not include a tri-organotin antifouling agent. The antifouling agents may be non-persistent antifouling agents. The one or more antifouling agents may be commercially available. The antifouling agent may be a non-copper and non-tri-organotin biocide. In some cases, the antifouling agent is a non-copper and non-tri-organotin biocide selected from the group consisting of tralopyril (TLP, ECONEA®, JANSSEN PMP, 4-bromo-2-(4-chlorophenyl)-5-(trifluoromethyl)-1H-pyrrole-3-carbonitrile), bronopol (2-bromo-2-nitro-propane-1,3-diol), 2,2′-dibromo-3-nitrilopropionamide, bis(1,4-bromoacetoxy)-2-butene, bis-(bromomethyl)sulfone, 1,2-dibromo-2,4-dicyanobutane, benzyl 2-bromoacetate, tetrabromobenzo-1,3-dinitrile, 4,5-dichloro-2-n-octyl-4-isothiazolin-3-one (DCOIT)(SEA-NINE® 211N in xylene (30 wt %), LANXESS or ROCIMA™ 200 water-based solution (20 wt %)), N-(dichlorofluoromethylthio)-N′,N′-dimethyl-N-phenylsulfamide (dichlofluanid, DCF, PREVENTOL® 4A-S, BAYER), bis(1-hydroxy-2(1H)-pyridinthionato-O,S) zinc (97%) (zinc pyrithione, ZnPT, JANSSEN PMP), 3-(3,4-dichlorophenyl)-1,1-dimethylurea (DCMU, Diuron, Drexel Chemical Company), 4-(1-(2,3-Dimethylphenyl)ethyl)-1H-imidazole (medetomidine), and zinc ethylenebis(dithiocarbamate) (polymeric) (Zineb, AGRIA SA). In some cases, the one or more antifouling agents may include tralopyril (4-bromo-2-(4-chlorophenyl)-5-(trifluoromethyl)-1H-pyrrole-3-carbonitrile), bronopol (2-bromo-2-nitro-propane-1,3-diol), 2,2′-dibromo-3-nitrilopropionamide, bis(1,4-bromoacetoxy)-2-butene, bis-(bromomethyl)sulfone, 1,2-dibromo-2,4-dicyanobutane, benzyl 2-bromoacetate, tetrabromobenzo-1,3-dinitrile, zinc pyrithione (Zinc omadine®, bis(2-pyridylthio)zinc 1,1′-dioxide, LONZA, INC.), or a combination thereof. The antifouling agent may include a non-metallic antifouling agent.

Tralopyril, 4-bromo-2-(4-chlorophenyl)-5-(trifluoromethyl)-1H-pyrrole-3-carbonitrile is a non-metallic antifouling agent. Tralopyril is available commercially, e.g., under tradename ECONEA®, Janssen PMP, Beerse, Belgium, and is approved under the EU BPR and US EPA. Tralopyril is a metal-free antifouling agent that exhibits a broad spectrum of activity against hard-shelled and soft-bodies invertebrate animal fouling organisms including barnacles, hydroids, mussels, oysters, and tube worms.

Zinc pyrithione is available commercially, e.g., under the tradename Zinc Omadine™, e.g., available from Arxada AG, Basel, Switzerland, formerly known as Lonza Specialty Ingredients, or Lonza Microbial Control, or as Zinc PYRION™ from Janssen PMP, and is registered with the Environmental Protection Agency (EPA). Zinc pyrithione may be employed as an antifouling agent for control of soft fouling marine organisms including seaweed, and bacterial and diatomaceous slimes. In some cases, the antifouling coating composition includes tralopyril and zinc pyrithione.

In some cases, the antifouling agent does not include a copper or tin derivative. The one or more antifouling agents may be used in the antifouling coating composition a concentration within a range of from 0-20 wt %, 0.5-15 wt %, 1-10 wt %, or 2-8 wt %.

### Pigments

Pigments may include any appropriate pigment. Pigment may be in the form of a paste or a powder. Pigments may include one or more of carbon black, titanium dioxide, zinc oxide, ferric oxide, mica pigments, and the like. In some cases, the pigment is a seawater soluble pigment. In some cases, the pigment is zinc oxide. In some cases, the pigment is a carbon black. In some cases, the carbon black pigment is MOGUL L, Cabot Corporation. The pigment may be used within a range of 0-10 wt %, 0.1-5 wt %, or 1-4 wt %.

### Methods

A method of making an antifouling coating composition is provided comprising blending a brominated epoxy resin in a solvent with a brominated additive using high shear mixing; optionally adding a surface additive during the mixing; and further optionally adding an antifouling agent during the mixing.

A method of reducing fouling of the underwater surface of a marine vessel is provided comprising applying an antifouling coating composition of the disclosure to the hull of the vessel; and allowing the composition to dry or cure. The method may include exposing at least a portion of the hull above the waterline, for example, by dry docking or careening the vessel; and preparing the surface of exposed hull prior to coating application. The preparing may include preparing the exposed hull. The preparing can include chemical, thermal and/or mechanical preparation of the exposed hull. Chemical preparation may include applying chemicals such as acids, alkaline solutions, oxidants, alcohols, etc. on the exposed surface to eliminate fat, oil, and salt.

### EXAMPLES

### Example 1. Antifouling Compositions

Several unfilled antifouling test compositions according to Table 4 were prepared by high shear mixing. The brominated epoxy resin was one of two liquid type brominated epoxy resins (Chang Chun Plastics Co., Ltd., Taiwan). The first brominated epoxy resin had a solid content of 64.0-66.0% in toluene, EEW 390-410 g/eq, viscosity 14-20 cps (25 deg C.). The second brominated epoxy resin had solid content 79-81% in acetone, EEW 425-445 g/eq, viscosity 1100-1900 cps at 25 deg C. The brominated additive was an aromatic reactive brominated additive 3,3′,5,5′-tetrabromo bisphenol A (TBBA). The polydimethylsiloxane additive was an epoxy-functional polydimethylsiloxane and/or a polyester-modified, hydroxy-functional polydimethylsiloxane. The optional antifouling agent was tralopyril and/or zinc pyrithione.

TABLE 4
Test Antifouling Compositions

| | | Amount | Amount | Amount |
|---|---|---|---|---|
| Material | Sample | (wt %) | (wt %) | (wt %) |
| Brominated | Solvent based | 60-95 wt % | 60-95 wt % | 60-95 wt % |
| Epoxy | brominated | | | |
| Resin | epoxy resin | | | |
| Brominated | aromatic | 4-10 wt % | 0-10 wt % | 0-10 wt % |
| Additive | reactive | | | |
| | brominated | | | |
| | additive | | | |
| Surface | epoxy- | 0.1-10 wt % | 0-10 wt % | 0-10 wt % |
| additive | functional | | | |
| | polydimethyl- | | | |
| | siloxane | | | |
| Surface | polyester- | 0.12-1 wt % | 0-1 wt % | 0-1 wt % |
| additive | modified, | | | |
| | hydroxy- | | | |
| | functional | | | |
| | polydimethyl- | | | |
| | siloxane | | | |
| Antifouling | Tralopyril | 0-10 wt % | 0.1-10 wt % | 0-10 wt % |
| agent | | | | |
| Antifouling | Zinc pyrithione | 0-10 wt % | 0-10 wt % | 0.1-10 wt % |
| agent | | | | |

Several specific test antifouling formulations were prepared as shown in Table 5A-G. In Tables 5A-G, six commercially available brominated epoxy resins were tested.

Resin 1 was a liquid type brominated epoxy resin with EEW (g/eq) 390-410, viscosity (cps, 25 deg C.) 14-20, solid content 64-66% in toluene.

Resin 2 was a liquid type brominated epoxy resin with EEW (g/eq) on solids 425-440 by ASTM D-1652, viscosity (mPa·s, 25 deg C.) 1500-2500 by ASTM D-445, bromine content on resin solids 19.5-21.5 calculated, solid content 80% in acetone.

Resin 3 was a solid type brominated epoxy resin with EEW (g/eq) of 305-355 by ASTM D-1652, bromine content 46-51%, calculated, and was dispersed at 50 wt % in toluene.

Resin 4 was a solid type brominated epoxy resin with EEW (g/eq) of 305-355 by ASTM D-1652, bromine content 46-51%, calculated, and was dispersed at 50 wt % in 60:40 toluene/dimethylacetamide.

Resin 5 was a solid type brominated epoxy resin with EEW (g/eq) of 380-410, and a bromine content of 50%, calculated, and was dispersed at 65 wt % in toluene.

Resin 6 was a liquid type brominated epoxy resin with EEW (g/eq) 425-445 by ASTM D1652, bromine content 18-21 wt %, viscosity at 25 deg C. 12-20 P by ASTM D445, and solid content 80% in acetone.

Resin 7 was a solid reaction product of epichlorohydrin and bisphenol A 75 wt % dissolved in toluene and having an EEW (g/eq) 425-450 by ASTM D1652. This is a non-brominated epoxy resin system.

The brominated additive was TBBA. Dispersing agent was a polyglycol-polyester-modified polyalkyleneimine, tin-free Disperbyk-2151 TF. Rheology modifying agent was a fumed silica AEROSIL 200. The pigment was a carbon black pigment was MOGUL L.

TABLE 5A
Test Formulations

| | Material | | | | | | | |
|---|---|---|---|---|---|---|---|---|
| | Wt (g) | Wt. % | Wt (g) | Wt. % | Wt (g) | Wt. % | Wt (g) | Wt. % |
| | Label | | | | | | | |
| | 1TT | | 1P | | 1Q | | 1YY | |
| RESIN 1 | 131.55 | 87.70 | 0.00 | 0.00 | 0.00 | 0.00 | 0.00 | 0.00 |
| RESIN 2 | 0.00 | 0.00 | 0.00 | 0.00 | 131.55 | 87.70 | 0.00 | 0.00 |
| RESIN 3 | 0.00 | 0.00 | 131.55 | 87.70 | 0.00 | 0.00 | 147.39 | 84.22 |
| RESIN 4 | 0.00 | 0.00 | 0.00 | 0.00 | 0.00 | 0.00 | 0.00 | 0.00 |
| RESIN 5 | 0.00 | 0.00 | 0.00 | 0.00 | 0.00 | 0.00 | 0.00 | 0.00 |
| RESIN 6 | 0.00 | 0.00 | 0.00 | 0.00 | 0.00 | 0.00 | 0.00 | 0.00 |
| Methyl ethyl ketone (solvent) | 0.00 | 0.00 | 0.00 | 0.00 | 0.00 | 0.00 | 0.00 | 0.00 |
| Disperbyk-2151 TF | 0.00 | 0.00 | 0.00 | 0.00 | 0.00 | 0.00 | 2.58 | 1.48 |
| (dispersing agent) | | | | | | | | |
| Aerosil 200 (rheology | 0.00 | 0.00 | 0.00 | 0.00 | 0.00 | 0.00 | 0.88 | 0.50 |
| modifying filler) | | | | | | | | |
| Mogul L (carbon black | 0.00 | 0.00 | 0.00 | 0.00 | 0.00 | 0.00 | 2.63 | 1.50 |
| pigment) | | | | | | | | |
| Surfynol 420 (surfactant) | 0.00 | 0.00 | 0.00 | 0.00 | 0.00 | 0.00 | 0.00 | 0.00 |
| TBBA (brominated additive) | 4.50 | 3.00 | 4.50 | 3.00 | 4.50 | 3.00 | 5.25 | 3.00 |
| Econea (biocide) | 4.50 | 3.00 | 4.50 | 3.00 | 4.50 | 3.00 | 5.25 | 3.00 |
| Zn Omadine (biocide) | 4.50 | 3.00 | 4.50 | 3.00 | 4.50 | 3.00 | 5.25 | 3.00 |
| BYK-3701 (surface additive) | 4.50 | 3.00 | 4.50 | 3.00 | 4.50 | 3.00 | 5.25 | 3.00 |
| BYK-307 (surface additive) | 0.45 | 0.30 | 0.45 | 0.30 | 0.45 | 0.30 | 0.53 | 0.30 |
| Total Formulation weight | 150 | 100.00 | 150 | 100.00 | 150 | 100.00 | 175 | 100.00 |

TABLE 5B
Test Formulations

| | Material | | | | | | | |
|---|---|---|---|---|---|---|---|---|
| | Wt (g) | Wt. % | Wt (g) | Wt. % | Wt (g) | Wt. % | Wt (g) | Wt. % |
| | Label | | | | | | | |
| | 1QQ | | 1ZZ | | 2Q | | 2S | |
| RESIN 1 | 323.28 | 81.52 | 0.00 | 0.00 | 0.00 | 0.00 | 0.00 | 0.00 |
| RESIN 2 | 0.00 | 0.00 | 0.00 | 0.00 | 0.00 | 0.00 | 0.00 | 0.00 |
| RESIN 3 | 0.00 | 0.00 | 0.00 | 0.00 | 0.00 | 0.00 | 0.00 | 0.00 |
| RESIN 4 | 0.00 | 0.00 | 161.64 | 80.82 | 0.00 | 0.00 | 0.00 | 0.00 |
| RESIN 5 | 0.00 | 0.00 | 0.00 | 0.00 | 153.48 | 87.70 | 0.00 | 0.00 |
| RESIN 6 | 0.00 | 0.00 | 0.00 | 0.00 | 0.00 | 0.00 | 118.48 | 67.70 |
| Methyl ethyl ketone (solvent) | 0.00 | 0.00 | 0.00 | 0.00 | 0.00 | 0 | 35.00 | 20.00 |
| Disperbyk-2151 TF | 6.72 | 1.68 | 3.76 | 1.88 | 0.00 | 0.00 | 0.00 | 0.00 |
| (dispersing agent) | | | | | | | | |
| Aerosil 200 (rheology | 4.00 | 1.00 | 3.00 | 1.50 | 0.00 | 0.00 | 0.00 | 0.00 |
| modifying filler) | | | | | | | | |
| Mogul L (carbon black | 14.00 | 3.50 | 7.00 | 3.50 | 0.00 | 0.00 | 0.00 | 0.00 |
| pigment) | | | | | | | | |
| Surfynol 420 (surfactant) | 0.00 | 0.00 | 0.00 | 0.00 | 0.00 | 0.00 | 0.00 | 0.00 |
| TBBA (brominated additive) | 12.00 | 3.00 | 6.00 | 3.00 | 5.25 | 3.00 | 5.25 | 3.00 |
| Econea (biocide) | 12.00 | 3.00 | 6.00 | 3.00 | 5.25 | 3.00 | 5.25 | 3.00 |
| Zn Omadine (biocide) | 12.00 | 3.00 | 6.00 | 3.00 | 5.25 | 3.00 | 5.25 | 3.00 |
| BYK-3701 (surface additive) | 12.00 | 3.00 | 6.00 | 3.00 | 5.25 | 3.00 | 5.25 | 3.00 |
| BYK-307 (surface additive) | 1.20 | 0.30 | 0.60 | 0.30 | 0.53 | 0.30 | 0.53 | 0.30 |
| Total Formulation weight | 400 | 100.00 | 200 | 100.00 | 175 | 100.00 | 175 | 100.00 |

TABLE 5C
Test Formulations

| | Material | | | | | | | |
|---|---|---|---|---|---|---|---|---|
| | Wt (g) | Wt.% | Wt (g) | Wt.% | Wt (g) | Wt.% | Wt (g) | Wt.% |
| | Label | | | | | | | |
| | 1AA | | 1BB | | 1CC | | 1JJ | |
| RESIN 1 | 136.05 | 90.70 | 127.05 | 84.70 | 122.55 | 81.70 | 136.05 | 90.70 |
| RESIN 2 | 0.00 | 0.00 | 0.00 | 0.00 | 0.00 | 0.00 | 0.00 | 0.00 |
| RESIN 3 | 0.00 | 0.00 | 0.00 | 0.00 | 0.00 | 0.00 | 0.00 | 0.00 |
| RESIN 4 | 0.00 | 0.00 | 0.00 | 0.00 | 0.00 | 0.00 | 0.00 | 0.00 |
| RESIN 5 | 0.00 | 0.00 | 0.00 | 0.00 | 0.00 | 0.00 | 0.00 | 0.00 |
| RESIN 6 | 0.00 | 0.00 | 0.00 | 0.00 | 0.00 | 0.00 | 0.00 | 0.00 |
| Methyl ethyl ketone (solvent) | 0.00 | 0.00 | 0.00 | 0.00 | 0.00 | 0.00 | 0.00 | 0.00 |
| Disperbyk-2151 TF | 0.00 | 0.00 | 0.00 | 0.00 | 0.00 | 0.00 | 0.00 | 0.00 |
| (dispersing agent) | | | | | | | | |
| Aerosil 200 (rheology | 0.00 | 0.00 | 0.00 | 0.00 | 0.00 | 0.00 | 0.00 | 0.00 |
| modifying filler) | | | | | | | | |
| Mogul L (carbon black | 0.00 | 0.00 | 0.00 | 0.00 | 0.00 | 0.00 | 0.00 | 0.00 |
| pigment) | | | | | | | | |
| Surfynol 420 (surfactant) | 0.00 | 0.00 | 0.00 | 0.00 | 0.00 | 0.00 | 0.00 | 0.00 |
| TBBA (brominated additive) | 4.50 | 3.00 | 4.50 | 3.00 | 4.50 | 3.00 | 4.50 | 3.00 |
| Econea (biocide) | 0.00 | 0.00 | 9.00 | 6.00 | 13.50 | 9.00 | 4.50 | 3.00 |
| Zn Omadine (biocide) | 4.50 | 3.00 | 4.50 | 3.00 | 4.50 | 3.00 | 0.00 | 0.00 |
| BYK-3701 (surface additive) | 4.50 | 3.00 | 4.50 | 3.00 | 4.50 | 3.00 | 4.50 | 3.00 |
| BYK-307 (surface additive) | 0.45 | 0.30 | 0.45 | 0.30 | 0.45 | 0.30 | 0.45 | 0.30 |
| Total Formulation weight | 150 | 100.00 | 150 | 100.00 | 150 | 100.00 | 150 | 100.00 |

TABLE 5D
Test Formulations

| | Material | | | | | | | |
|---|---|---|---|---|---|---|---|---|
| | Wt (g) | Wt. % | Wt (g) | Wt. % | Wt (g) | Wt. % | Wt (g) | Wt. % |
| | Label | | | | | | | |
| | 1KK | | 1LL | | 1H | | 2A | |
| RESIN 1 | 127.05 | 84.70 | 122.55 | 81.70 | 105.60 | 85.87 | 263.10 | 87.70 |
| RESIN 2 | 0.00 | 0.00 | 0.00 | 0.00 | 0.00 | 0.00 | 0.00 | 0.00 |
| RESIN 3 | 0.00 | 0.00 | 0.00 | 0.00 | 0.00 | 0.00 | 0.00 | 0.00 |
| RESIN 4 | 0.00 | 0.00 | 0.00 | 0.00 | 0.00 | 0.00 | 0.00 | 0.00 |
| RESIN 5 | 0.00 | 0.00 | 0.00 | 0.00 | 0.00 | 0.00 | 0.00 | 0.00 |
| RESIN 6 | 0.00 | 0.00 | 0.00 | 0.00 | 0.00 | 0.00 | 0.00 | 0.00 |
| Methyl ethyl ketone (solvent) | 0.00 | 0.00 | 0.00 | 0.00 | 0.00 | 0.00 | 0.00 | 0.00 |
| Disperbyk-2151 TF | 0.00 | 0.00 | 0.00 | 0.00 | 0.40 | 0.33 | 0.00 | 0.00 |
| (dispersing agent) | | | | | | | | |
| Aerosil 200 (rheology | 0.00 | 0.00 | 0.00 | 0.00 | 1.80 | 1.46 | 0.00 | 0.00 |
| modifying filler) | | | | | | | | |
| Mogul L (carbon black | 0.00 | 0.00 | 0.00 | 0.00 | 0.00 | 0.00 | 0.00 | 0.00 |
| pigment) | | | | | | | | |
| Surfynol 420 (surfactant) | 0.00 | 0.00 | 0.00 | 0.00 | 0.90 | 0.73 | 0.00 | 0.00 |
| TBBA (brominated additive) | 4.50 | 3.00 | 4.50 | 3.00 | 3.48 | 2.83 | 9.00 | 3.00 |
| Econea (biocide) | 4.50 | 3.00 | 4.50 | 3.00 | 3.48 | 2.83 | 9.00 | 3.00 |
| Zn Omadine (biocide) | 9.00 | 6.00 | 13.50 | 9.00 | 3.48 | 2.83 | 9.00 | 3.00 |
| BYK-3701 (surface additive) | 4.50 | 3.00 | 4.50 | 3.00 | 3.48 | 2.83 | 9.00 | 3.00 |
| BYK-307 (surface additive) | 0.45 | 0.30 | 0.45 | 0.30 | 0.35 | 0.29 | 0.90 | 0.30 |
| RSC-4628 (aminosilane | 0.00 | 0.00 | 0.00 | 0.00 | 32.15 | 20.73 | 80.13 | 21.08 |
| curing agent) | | | | | | | | |
| Total Formulation weight | 150 | 100.00 | 150 | 100.00 | 155.12 | 100.00 | 380.13 | 100.00 |

TABLE 5E
Test Formulations

| | Material | | | | | | | |
|---|---|---|---|---|---|---|---|---|
| | Wt (g) | Wt.% | Wt (g) | Wt.% | Wt (g) | Wt.% | Wt (g) | Wt.% |
| | Label | | | | | | | |
| | 2B | | 2D | | 2N | | 2O | |
| RESIN 1 | 263.10 | 87.70 | 140.55 | 93.70 | 144.71 | 87.70 | 158.73 | 90.70 |
| RESIN 2 | 0.00 | 0.00 | 0.00 | 0.00 | 0.00 | 0.00 | 0.00 | 0.00 |
| RESIN 3 | 0.00 | 0.00 | 0.00 | 0.00 | 0.00 | 0.00 | 0.00 | 0.00 |
| RESIN 4 | 0.00 | 0.00 | 0.00 | 0.00 | 0.00 | 0.00 | 0.00 | 0.00 |
| RESIN 5 | 0.00 | 0.00 | 0.00 | 0.00 | 0.00 | 0.00 | 0.00 | 0.00 |
| RESIN 6 | 0.00 | 0.00 | 0.00 | 0.00 | 0.00 | 0.00 | 0.00 | 0.00 |
| 65 wt. % in toluene | | | | | | | | |
| Methyl ethyl ketone (solvent) | 0.00 | 0.00 | 0.00 | 0.00 | 0.00 | 0.00 | 0.00 | 0.00 |
| Disperbyk-2151 TF | 0.00 | 0.00 | 0.00 | 0.00 | 0.00 | 0.00 | 0.00 | 0.00 |
| (dispersing agent) | | | | | | | | |
| Aerosil 200 (rheology | 0.00 | 0.00 | 0.00 | 0.00 | 0.00 | 0.00 | 0.00 | 0.00 |
| modifying filler) | | | | | | | | |
| Mogul L (carbon black | 0.00 | 0.00 | 0.00 | 0.00 | 0.00 | 0.00 | 0.00 | 0.00 |
| pigment) | | | | | | | | |
| Surfynol 420 (surfactant) | 0.00 | 0.00 | 0.00 | 0.00 | 0.00 | 0.00 | 0.00 | 0.00 |
| TBBA (brominated additive) | 9.00 | 3.00 | 4.50 | 3.00 | 4.95 | 3.00 | 0.00 | 0.00 |
| Econea (biocide) | 9.00 | 3.00 | 0.00 | 0.00 | 4.95 | 3.00 | 5.25 | 3.00 |
| Zn Omadine (biocide) | 9.00 | 3.00 | 0.00 | 0.00 | 4.95 | 3.00 | 5.25 | 3.00 |
| BYK-3701 (surface additive) | 9.00 | 3.00 | 4.50 | 3.00 | 4.95 | 3.00 | 5.25 | 3.00 |
| BYK-307 (surface additive) | 0.90 | 0.30 | 0.45 | 0.30 | 0.50 | 0.30 | 0.53 | 0.30 |
| RSC-4628 (aminosilane | 40.06 | 11.78 | 0.00 | 0.00 | 0.00 | 0.00 | 0.00 | 0.00 |
| curing agent) | | | | | | | | |
| Total Formulation weight | 340.06 | 100.00 | 150 | 100.00 | 165 | 100.00 | 175 | 100.00 |

TABLE 5F
Test Formulations

| | Material | | | | | | | |
|---|---|---|---|---|---|---|---|---|
| | Wt (g) | Wt. % | Wt (g) | Wt. % | Wt (g) | Wt. % | Wt (g) | Wt. % |
| | Label | | | | | | | |
| | 2H | | 2I | | 1UU | | 1VV | |
| RESIN 1 | 0.00 | 0.00 | 0.00 | 0.00 | 158.73 | 90.70 | 122.55 | 81.70 |
| RESIN 2 | 0.00 | 0.00 | 0.00 | 0.00 | 0.00 | 0.00 | 0.00 | 0.00 |
| RESIN 3 | 0.00 | 0.00 | 0.00 | 0.00 | 0.00 | 0.00 | 0.00 | 0.00 |
| RESIN 4 | 153.48 | 87.70 | 158.73 | 90.70 | 0.00 | 0.00 | 0.00 | 0.00 |
| RESIN 5 | 0.00 | 0.00 | 0.00 | 0.00 | 0.00 | 0.00 | 0.00 | 0.00 |
| RESIN 6 | 0.00 | 0.00 | 0.00 | 0.00 | 0.00 | 0.00 | 0.00 | 0.00 |
| Methyl ethyl ketone | 0.00 | 0.00 | 0.00 | 0.00 | 0.00 | 0.00 | 0.00 | 0.00 |
| (solvent) | | | | | | | | |
| Disperbyk-2151 TF | 0.00 | 0.00 | 0.00 | 0.00 | 0.00 | 0.00 | 0.00 | 0.00 |
| (dispersing agent) | | | | | | | | |
| Aerosil 200 (rheology | 0.00 | 0.00 | 0.00 | 0.00 | 0.00 | 0.00 | 0.00 | 0.00 |
| modifying filler) | | | | | | | | |
| Mogul L (carbon black | 0.00 | 0.00 | 0.00 | 0.00 | 0.00 | 0.00 | 0.00 | 0.00 |
| pigment) | | | | | | | | |
| Surfynol 420 (surfactant) | 0.00 | 0.00 | 0.00 | 0.00 | 0.00 | 0.00 | 0.00 | 0.00 |
| TBBA (brominated | 5.25 | 3.00 | 0.00 | 0.00 | 0.00 | 0.00 | 13.50 | 9.00 |
| additive) | | | | | | | | |
| Econea (biocide) | 5.25 | 3.00 | 5.25 | 3.00 | 5.25 | 3.00 | 4.50 | 3.00 |
| Zn Omadine (biocide) | 5.25 | 3.00 | 5.25 | 3.00 | 5.25 | 3.00 | 4.50 | 3.00 |
| BYK-3701 (surface | 5.25 | 3.00 | 5.25 | 3.00 | 5.25 | 3.00 | 4.50 | 3.00 |
| additive) | | | | | | | | |
| BYK-307 (surface | 0.53 | 0.30 | 0.53 | 0.30 | 0.53 | 0.30 | 0.45 | 0.30 |
| additive) | | | | | | | | |
| Total Formulation | 175 | 100.00 | 175 | 100.00 | 175 | 100.00 | 150 | 100.00 |
| weight | | | | | | | | |

TABLE 5G
Test Formulations

| Material | Wt (g) | Wt. % |
|---|---|---|
| Label | 1XX | |
| RESIN 1 | 0.00 | 0.00 |
| RESIN 2 | 131.55 | 81.70 |
| RESIN 3 | 0.00 | 0.00 |
| RESIN 4 | 0.00 | 0.00 |
| RESIN 5 | 0.00 | 0.00 |
| RESIN 6 | 0.00 | 0.00 |
| Methyl ethyl ketone (solvent) | 0.00 | 0.00 |
| Disperbyk-2151 TF | 0.00 | 0.00 |
| (dispersing agent) | | |
| Aerosil 200 (rheology | 0.00 | 0.00 |
| modifying filler) | | |
| Mogul L (carbon black | 0.00 | 0.00 |
| pigment) | | |
| Surfynol 420 (surfactant) | 0.00 | 0.00 |
| TBBA (brominated additive) | 4.50 | 3.00 |
| Econea (biocide) | 4.50 | 3.00 |
| Zn Omadine (biocide) | 4.50 | 3.00 |
| BYK-3701 (surface additive) | 4.50 | 3.00 |
| BYK-307 (surface additive) | 0.45 | 0.30 |
| Total Formulation weight | 150 | 100.00 |

The formulations shown in Tables 4 and 5A to 5G were prepared and tested in seawater immersion and biological assays as described below.

### Example 2. Antifouling Coating Seawater Immersion Assay Testing

Example 2A. In the present preliminary test, three test antifouling coating samples were prepared as described in Example 1, Table 4 and two comparative samples and used to coat 6 in.×6 in.×⅛ in. fiberglass panels which had previously been sanded to obtain a roughened surface. The panels were immersed in Intracoastal Waterway, Jupiter, Florida over a March to May time period. The sea water temperature from March to May in Intracoastal Waterway, Jupiter, Florida may typically range from 73.6 deg F. (23.1 deg C.) to 83.1 deg F. (28.5 deg C.). The conditions in this area are conducive to the development of fouling organisms, such as algae and invertebrates such as barnacles. The panels were withdrawn at weekly intervals, inspected, and the percent invertebrate coverage, and percent macroalgae coverage of the most fouled panel surface were determined.

The two comparative control foul release coatings PROPSPEED® coating (Oceanmax) and HULL MAXX™ (Nasco Worldwide). Comparative Sample 1 (PROPSPEED®) is a coating for propellers and metal running gear as an alternative to antifouling toxic paint. PROPSPEED® treatment is said to impart an ultra-slick surface that marine growth finds difficult to adhere, thus is said to be a foul-release coating, not an anti-foulant. PROPSPEED® is typically applied to a metal part below the waterline. PROPSPEED® is gold in color due to an etching primer. Proper cleaning and surface preparation may include sanding and cleaning leaves a surface matrix residue for the PROPSPEED® zinc chromate polymer etch primer to chemically bond to metal substrate, followed by a silicone clear coat resulting in a slippery surface easily washed by hydrodynamic pressure. Comparative sample 2 (% ULL MAX™) is a clear non-toxic foul-release coating to prevent hull fouling.

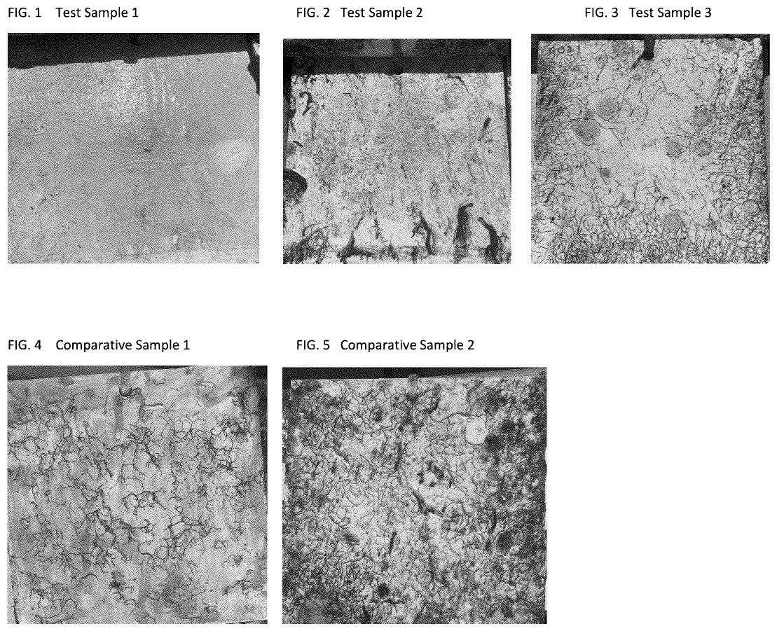

After 42 days, the coated test panels were photographed for visual appearance. Photographs of representative samples are shown in FIGS. 1-5. Fouling results are shown in Table 6.

TABLE 6
Coating Seawater Testing

| | | Macroalgae | Invertebrate |
|---|---|---|---|
| Sample Name | Time in water | coverage | coverage |
| Test Sample 1 | 42 days | <5% | <5% |
| Test Sample 2 | 42 days | 10-25% | <5% |
| Test Sample 3 | 42 days | 10-25% | 10-25% |
| Comparative | 42 days | 10-25% | <5% |
| Sample 1 | | | |
| (PROPSPEED ®) | | | |
| Comparative | 42 days | >25% | 10-25% |
| Sample 2 | | | |
| (HULL MAXX ™) | | | |

Test sample 1 exhibited <5% macroalgae coverage and <5% invertebrate coverage after being immersed in seawater for at least 42 days.

Test sample 2 exhibited 10-25% macroalgae coverage and <5% invertebrate coverage after being immersed in seawater for at least 42 days.

Test sample 3 exhibited Test sample 2 exhibited 10-25% macroalgae coverage and 10-25% invertebrate coverage after being immersed in seawater for at least 42 days.

Comparative sample 1 exhibited 10-25% macroalgae coverage and <5% invertebrate coverage after being immersed in seawater for at least 42 days.

Comparative sample 2 exhibited >25% macroalgae coverage and 10-25% invertebrate coverage after being immersed in seawater for at least 42 days.

### Example 2B. Evaluation of Different Brominated Epoxy Resins

Several brominated epoxies were evaluated in the Seawater Immersion Assay performed according to example 2A. The brominated epoxy resins included RESIN 1, RESIN 2, RESIN 3, RESIN 4, RESIN 5, and RESIN 6 as described above. The formulations were each prepared with the same brominated additive, biocide, and surface additive composition including tetrabromobisphenol A (TBBA), tralopyril (ECONEA), zinc pyrithione (ZINC OMADINE®), epoxy-functional polydimethylsiloxane (e.g., BYK-Silclean 3701=BYK-3701) and polyether-modified polydimethylsiloxane (BYK-307), respectively. The seawater immersion test results were obtained with respect to the antifouling performance.

Test formulations with changes in the brominated epoxy resin system, but keeping the same base additive and biocide package included:
1A=RESIN 1;
1P=RESIN 3;
1Q=RESIN 2;
2Q=RESIN 5; and
2S=RESIN 6.

Test formulations with changes in the brominated resin system, but keeping the same base additive and biocide package, as well as adding fillers and/or pigments, included:
1YY=RESIN 3 with black pigment, rheology modifier, and dispersant;
1QQ=RESIN 1 with black pigment, rheology modifier, and dispersant;
1ZZ=RESIN 4 with black pigment, rheology modifier, and dispersant; and
1TT=RESIN 1 formulation with standard level of biocide and additives.

Each of 1TT, 1P, 1Q, 1YY, 1QQ, 1ZZ, 2Q, and 2S included a non-curing 1K formulation with standard level of biocide and additives.

Commercial control samples are shown in table 7.

TABLE 7
Commercial control samples

| Label | Formulation ID | Description |
|---|---|---|
| C1 | Micron CSC White | Commercially available self-polishing, |
| | | copper containing paint |
| C2 | Colorkote White | Commercially available self-polishing, |
| | | copper containing paint |
| C3 | Micron CSC Black | Commercially available self-polishing, |
| | | copper containing paint |
| C4 | Colorkote Black | Commercially available self-polishing, |
| | | copper containing paint |
| C0 | Blank Fiberglass | Fiberglass panel used for field immersion |
| | | studies. Negative control |
| 2C1 | Micron CSC White | Commercially available self-polishing, |
| | | copper containing paint |
| 2C2 | Colorkote White | Commercially available self-polishing, |
| | | copper containing paint |
| 2C0 | Blank Fiberglass | Fiberglass panel used for field immersion |
| | | studies. Negative control |
| 3C2 | Colorkote White | Commercially available self-polishing, |
| | | copper containing paint |
| 3C0 | Blank Fiberglass | Fiberglass panel used for field immersion |
| | | studies. Negative control |

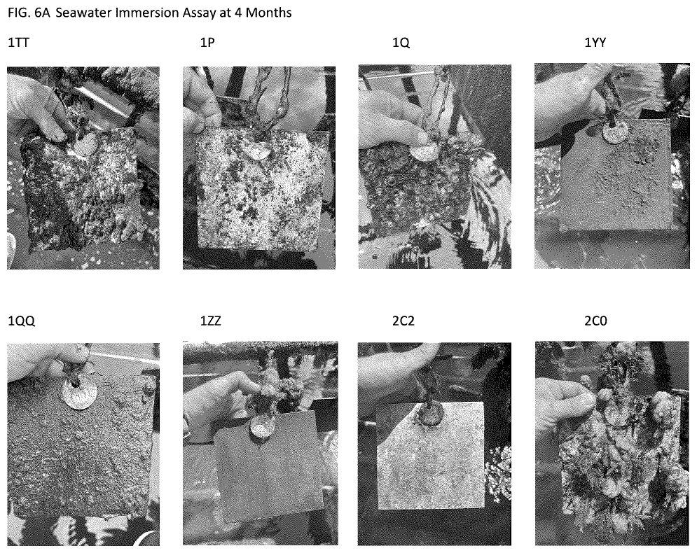

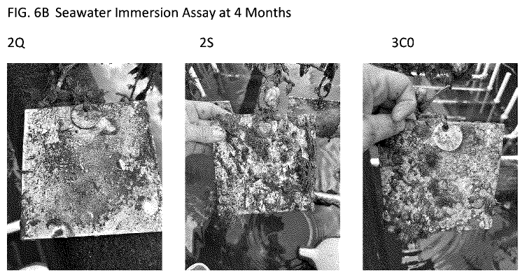

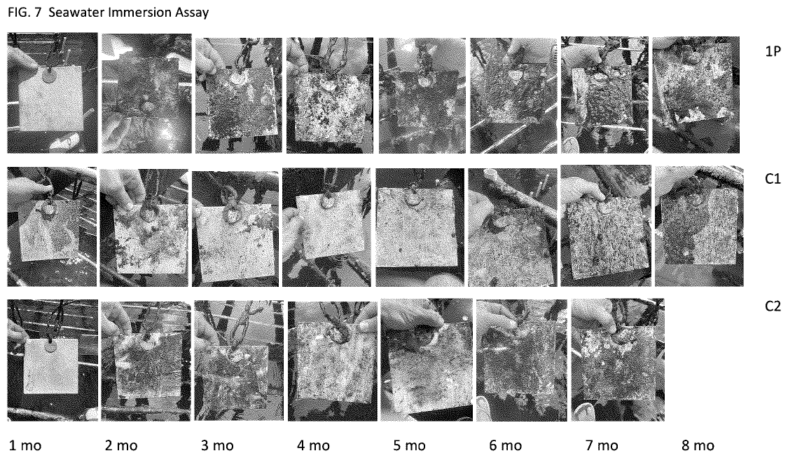

Photographs of the test panels after 4 months in the seawater immersion test are shown in FIGS. 6 and 7. FIG. 6A shows photographic results of Seawater Immersion Assay after 4 months for copper-free test formulation panels 1TT, 1P, 1Q, 1YY, 1QQ, 1ZZ, comparative control 2C2 commercial copper-containing paint, and 2C0 blank fiberglass panel negative control. FIG. 6B shows photographic results of Seawater Immersion Assay after 4 months for copper-free test formulation panels 2Q and 2S and control 3C0 blank fiberglass panel negative control.

Results: Changing the type of brominated resin (RESIN 1/RESIN 2/RESIN 3/RESIN 4/RESIN 5/RESIN 6) significantly affects anti-fouling performance after 4 months in the Seawater Immersion Assay. For example, RESIN 3 formulation 1YY appeared to exhibit less fouling than RESIN 1 formulation 1QQ as shown in FIG. 6A. Formulations with RESIN 3 and RESIN 4 (e.g., 1YY, 1ZZ, 1P) exhibited excellent performance on par with commercial copper-containing antifouling paints COLORKOTE (e.g., 2C2) and MICRON CSC (e.g., C1, C3, 2C1). As another example, RESIN 3 formulation 1P appeared to exhibit less fouling than RESIN 2-formulation 1Q as shown in FIG. 6A.

Adding dispersing agent, rheology filler, and carbon black pigment enhanced antifouling performance in the RESIN 1 formulation, for example when comparing RESIN 1 formulation 1TT to RESIN 1 formulation 1QQ as shown in FIG. 6A.

### Example 2C. Effect of Biocide Concentrations

Formulations were prepared having various amounts of Econea and/or zinc pyrithione and compared with formulations that contained 2× or 3× the standard amount of these biocides. The RESIN 1 brominated epoxy resin was used in these formulations keeping the remaining composition similar to standard formulation 1TT as follows:
1AA=RESIN 1 resin system with no Econea;
1BB=RESIN 1 resin system with 2× Econea;
1CC=RESIN 1 resin system with 3× Econea;
1JJ=RESIN 1 resin system with no zinc pyrithione;
1KK=RESIN 1 resin system with 2× zinc pyrithione;
1LL=RESIN 1 resin system with 3× zinc pyrithione; and
1TT=Standard RESIN 1 resin system.

Each of the formulations 1AA, 1BB, 1CC, 1JJ, 1KK, 1LL, and 1TT was a non-curing 1K formulation.

Comparative control formulations are shown in Table 7.

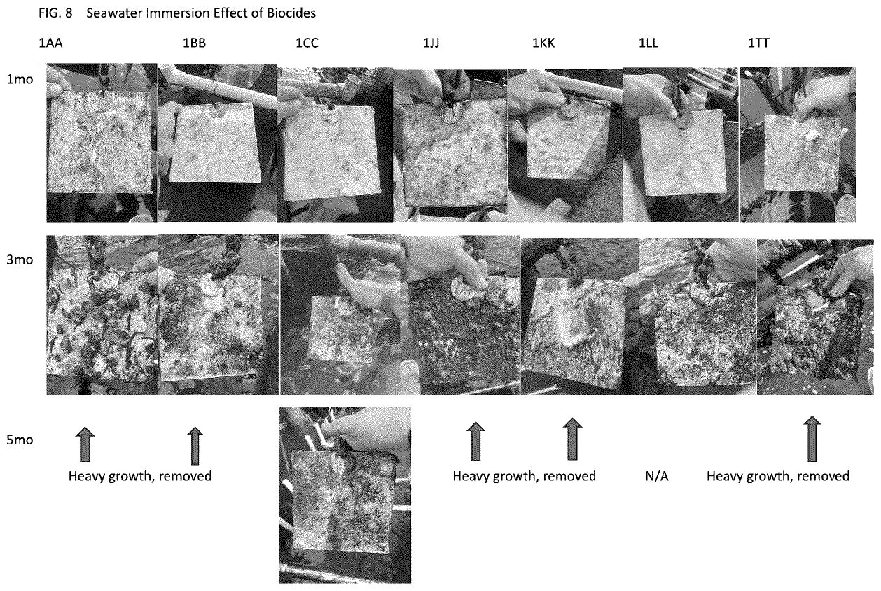

Removing biocide Econea from RESIN 1 formulation significantly reduces anti-fouling performance, as shown in FIG. 8 when comparing Formulations 1AA (0% Econea), to 1BB (6% Econea), 1CC (9% Econea), and 1TT (3% Econea) at 1 and 3 months. At 5 months, panels coated with test formulations 1AA, 1BB and 1TT exhibited heavy growth and were removed from the assay. Test sample formulations which did not contain either Econea (1AA) (0% Econea), or zinc pyrithione (1JJ) (0% zinc pyrithione), exhibited poor anti-fouling performance. Test sample formulations with increased Econea or zinc pyrithione to 3-fold, i.e., formulations 1CC or 1LL, respectively, exhibited significantly improved performance compared to the standard formulation 1TT.

### Example 2D. Effect of Crosslinking

Formulations 1H, 2A, 2B were prepared with the RESIN 1 resin and base additive and biocide compositions and cured with RSC-4628, an aminosilane curing agent 3-aminopropyltriethoxysilane (Gelest SAI0610.1). Formulations are described as follows.

1H=RESIN 1 brominated epoxy resin with standard additive and biocide package, Aerosil 200, dispersant, and surfactant. Cured at a 1.0:1.0 epoxy to amine ratio. This formulation was a curing 2K formulation with standard levels of biocide and additives, dispersing agent, rheology modifier, and surfactant.

2A=RESIN 1 brominated epoxy resin with standard additive and biocide package with additives cured at a 1.0:1.0 epoxy to amine ratio.

2B=RESIN 1 brominated epoxy resin with standard additive and biocide package with additives cured at a 1.0:0.5 epoxy to amine ratio.

1TT=RESIN 1 brominated epoxy resin. Non-curing 1K formulation with standard levels of biocide and additives.

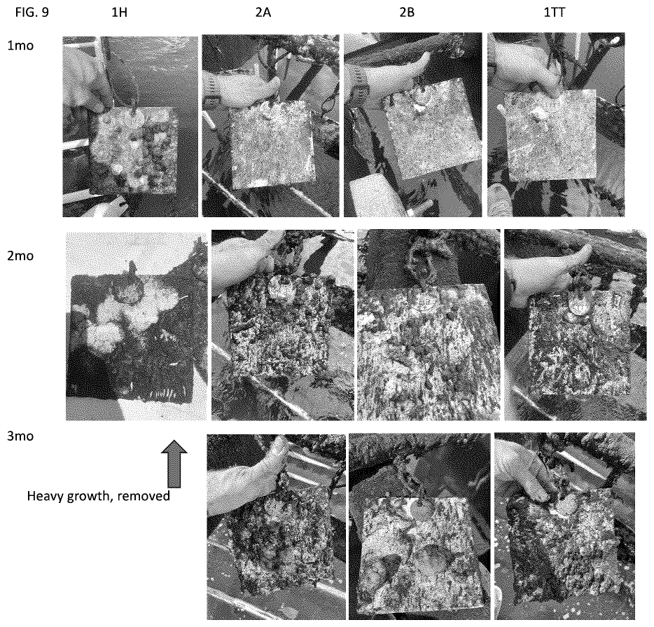

Comparative commercial formulations are shown in Table 7. The formulations were applied to panels and subjected to the seawater immersion assay as described in Example 2A. Results are shown in FIG. 9.

Sample formulations 1H, 2A, 2B that are cured with a curing agent RSC-4628 (an aminosilane curing agent) do not improve anti-fouling performance in formulations that utilize the RESIN 1 resin when compared to non-curing formulation 1TT. Reducing the crosslinking epoxy to amine ratio has a slight effect on anti-fouling performance, but does not significantly improve properties. A 1.0:0.5 epoxy to amine ratio (e.g., formulation 2B) performs slightly better than 1.0:1.0 (e.g., formulation 2A).

### Example 2E. Effect of Removing Both Biocides

In this example, the effect of removing both biocides: Econea and zinc pyrithione was examined. Several formulations were evaluated in the Seawater Immersion Assay performed according to example 2A. The contribution of the combination of zinc pyrithione and Econea was determined. The following formulations were prepared.

2D=standard RESIN 1 formulation but without Econea or zinc pyrithione. This was a 1K non-curing formulation.

1TT-standard RESIN 1 formulation. This was a 1K non-curing formulation.

2C0=bare fiberglass negative control.

2C2=commercially available control self-polishing Colorkote copper-containing paint.

Remaining controls are shown in Table 7.

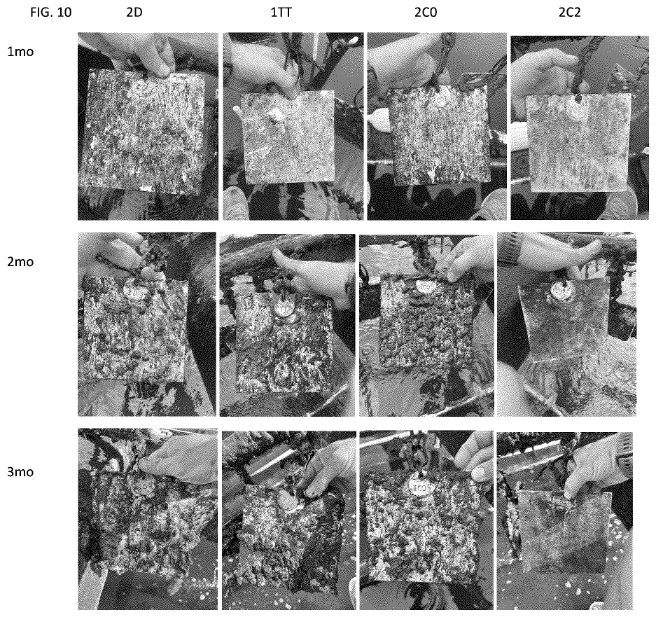

Results of the seawater immersion test over 3 months are shown in FIG. 10.

FIG. 10 shows brominated epoxy resin formulations with (1TT) and without (2D) biocides zinc pyrithione and Econea. When Econea and zinc pyrithione are both removed in formulations using RESIN 1. Negative control 2C0 shows results with untreated fiberglass panel. Control 2C2 commercial copper-containing paint shows good anti-fouling control over 3 months.

### Example 2F. Effect of Brominated Additive

In this example, anti-fouling test formulations were prepared using RESIN 1 or RESIN 4 with or without brominated additive TBBA. The following formulations were prepared:

2N=standard RESIN 1 formulation with TBBA, non-curing 1K formulation.

2O=standard RESIN 1 formulation without TBBA, non-curing 1K formulation.

2H=standard RESIN 4 with TBBA, non-curing 1K formulation.

2I=standard RESIN 4 without TBBA, non-curing 1K formulation.

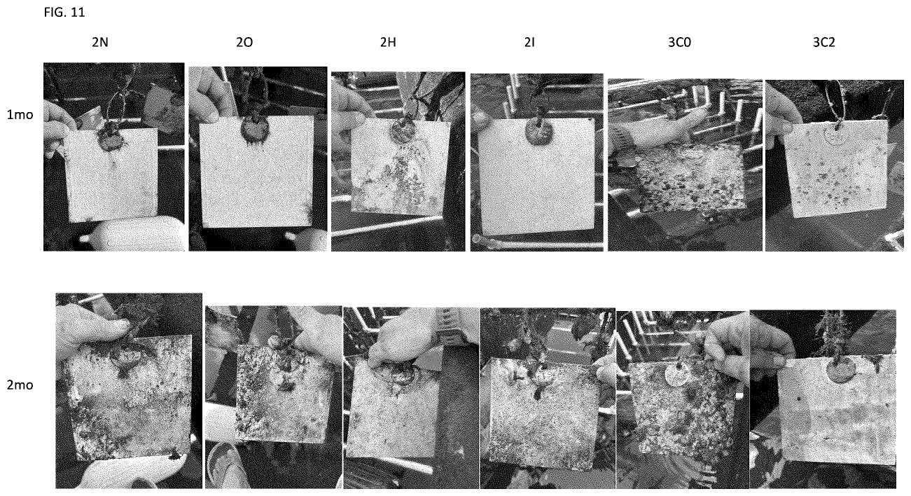

Treated fiberglass panels were subjected to the seawater immersion assay as described in example 2A. Control formulations are shown in Table 7. Results are shown in FIG. 11.

Anti-fouling effects over 2 months in the Seawater Immersion Assay are shown in FIG. 11 for two different brominated epoxy resins RESIN 1 and RESIN 4 with and without TBBA. In this example, after 2 months minor differences are seen between test panels.

### Example 3. Biological Assays

Three biological assays were performed to measure the extent of toxicity and biofilm growth on the experimental anti-fouling coating sample formulations of Tables 5A-F. The three biological assays included leachate toxicity assessments using brown microalgae Navicula incerta, green microalgae Chlorella vulgaris, and marine bacterium Cellulophaga lytica; microalgae cell attachment and biofilm growth assessments using the marine diatom Navicula incerta or Chlorella vulgaris; and bacteria biofilm growth assessments using the marine bacterium, Cellulophaga lytica.

### Example 3A. Leachate Toxicity Assessments

### Leachate Toxicity Assessments:

Leachate toxicity assessments were performed on an experimental sample set after 0 days of water ageing, and on another set of samples after being immersed in circulating tap water for 28 days. Three different microorganisms were evaluated including the brown microalgae Navicula incerta, green microalgae Chlorella vulgaris, and marine bacterium Cellulophaga lytica.

After performing the selected water ageing procedure (0 or 28 days of preleaching), 1.0 mL of growth medium in artificial seawater (ASW) was added to the coated samples in plastic 24-well plates, placed on an orbital shaker at 150 rpm for 24 hr at ambient conditions. After this time, coating leachates/extracts were collected and were inoculated with a 0.05 mL suspension of 10⁷ bacterial cells in a biofilm growth medium, or 0.05 mL of a 0.03 OD600 microalgae suspension in Guillard's F/2 medium and then 0.2 mL aliquots of the inoculated coating leachates were transferred to a 96-well plate. The bacterial leachates were then incubated for 24 hours at 28° C., and the microalgae for 48 hours at 18° C. in an illuminated growth cabinet with a 16:8 light:dark cycle. The bacterial plates were rinsed with deionized water 3 times and the biofilms that remained were stained with 0.5 mL of crystal violet dye solution in deionized water for 15 minutes. After this, 0.5 mL of 33% glacial acetic acid was added to each coating well to extract the crystal violet dye and absorbance measurements were made at 600 nm with a multi-well plate spectrophotometer. Microalgae leachate plates were quantified for growth by measuring chlorophyll fluorescence. If a >25% reduction in bacterial solution/biofilm or microalgae biofilm compared to a growth positive control, this was considered due to the release of toxic components from the experimental coating samples.

### Example 3B. Microalgae Cell Attachment and Biofilm Growth Assessments

Cultures of the marine diatom Navicula incerta or Chlorella vulgaris, that were aged 5 days, were re-suspended in fresh Guillard's F/2 medium prepared in ASW to achieve a final cell density of 105 cell/mL. Then, 1.0 ml of the resulting N. incerta or C. vulgaris suspension was added to the wells of the coating plates and incubated at 18° C. for 2 hours or 48 hours in an illuminated growth cabinet with a 16:8 light:dark cycle (photon flux density 33 mmol m−2 s−1) to ensure cell attachment and biofilm growth, respectively. Next, the coatings were extracted with 0.6 mL (cell attachment) or 1.0 mL (biofilm growth) of DMSO for 20 minutes and 0.15 mL of the resulting eluates was transferred to a 96-well plate and measured for fluorescence of chlorophyll (Ex: 360 nm; Em: 670 nm) using a multi-well plate spectrophotometer to quantify cell attachment and/or biofilm growth.

### Example 3C. Bacteria Biofilm Growth Assessments

Cultures of the marine bacterium, Cellulophaga lytica, were prepared in marine broth and harvested by centrifugation (10,000×g for 10 min) and rinsed three times with sterile ASW. The resulting C. lytica pellet was re-suspended in ASW and then used to inoculate bacterial growth media (BGM) to achieve a final cell density of 10⁷ to 108 cells/mL. Subsequently, 1.0 ml of the C. lytica resuspension in BGM was added to each well of the coating plates and incubated at 28° C. for 24 hours, then rinsed 3 times with deionized (DI) water, and stained with crystal violet dye for 15 min, followed by an additional 3 times rinse with DI water, and dried for 1 hour at ambient laboratory conditions. The biofilm-bound crystal violet was extracted from the biofilms on the coating surfaces by adding 0.5 ml of 33% acetic acid for 15 min and the resulting eluates transferred to a 96-well plate and measured for absorbance at 600 nm using a multi-well plate spectrophotometer to quantify biofilm growth. Unless otherwise specified, biological assay testing was performed by North Dakota State University (NDSU) Bioactive Materials Research Laboratory, Fargo, ND.

The biological assay testing samples are shown in Table 8.

TABLE 8
Biological Assay Testing Samples

| | | | Label |
|---|---|---|---|
| Column | Resin | Description | ID |
| 1 | RESIN 1 | Replicate of best performing formulation | 1TT |
| | | that was put in the water in the spring of | |
| | | 2023 | |
| 2 | RESIN 1 | Removed the TBBA bromine additive | 1UU |
| 3 | RESIN 1 | Tripled the amount of TBBA bromine | 1VV |
| | | additive | |
| 4 | RESIN 3 | Model 1K non-curing system but with | 1WW |
| | | RESIN 3 used instead of RESIN 1 | |
| 5 | RESIN 2 | Model 1K non-curing system but with | 1XX |
| | | RESIN 2-A80 used instead of RESIN 1 | |
| 6 | RESIN 3 | RESIN 3 with dispersant, Mogul L, | 1YY |
| | | Aerosil 200 with base biocide and | |
| | | additive composition | |
| 7 | RESIN 4 | RESIN 4 with dispersant, Mogul L, | 1ZZ |
| | | further increased amount of Aerosil 200 | |
| | | with base biocide and additive | |
| | | composition | |
| 8 | RESIN 1 | Model formulation used. Only change | 2A |
| | | was curing with RSC-4628; 2K system | |
| 9 | RESIN 1 | 1A 2K system with RSC-4628 but at a | 2B |
| | | 1:0.5 epoxy to amine ratio | |
| 10 | RESIN 7 | Best match for RESIN 1 without bromine | 2C |
| | | 1K system off of 1A non-brominated | |
| | | epoxy resin | |
| 11 | RESIN 1 | 1A without the econea and Zn | 2D |
| 12 | Acrylic | Colorkote white, commercially available | 2C2 |
| | SPC resin | copper containing SPC coating | |
| 13 | N/A | Dow Corning Silastic T2, a commercially | T2 |
| | | available silicone elastomer | |
| 14 | N/A | Generic polyurethane prepared by NDSU | PU |
| 15 | N/A | Intersleek 700, a commercially available | 700 |
| | | silicone fouling release paint | |
| 16 | N/A | Intersleek 900, a commercially available | 900 |
| | | silicone fouling release paint | |
| 17 | N/A | Intersleek 1100 SR, a commercially | 1100 SR |
| | | available silicone fouling release paint | |
| | | with slime release technology | |

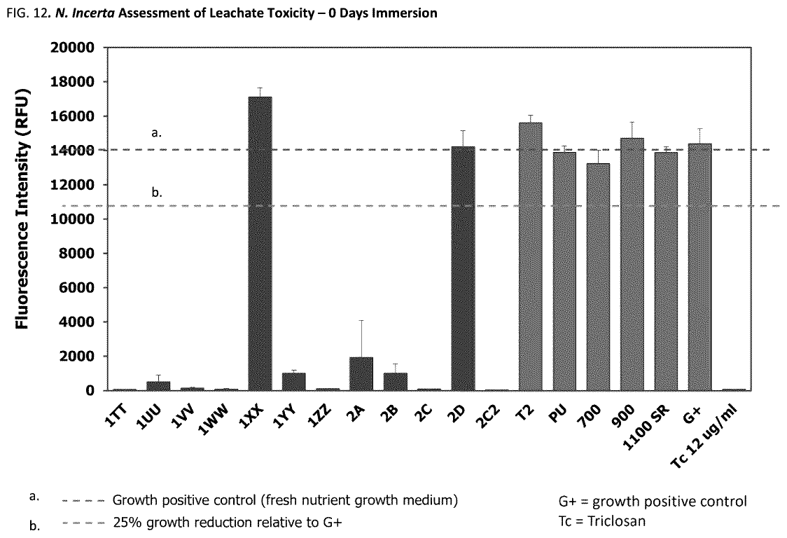

FIG. 12 shows results of N. incerta assessment of brown microalgal leachate toxicity after 0 days immersion as a bar graph of fluorescence intensity (RFU) for the test formulations 1TT, 1UU, 1VV, 1WW, 1XX, 1YY, 1ZZ, 2A, 2B3, 2C, 2D) and control formulations 2C2, T2, PU, 700, 900, 1100SR. G+ is the growth positive control, Tc is Triclosan. Formulations 1TT, 1UU, 1VV, 1WW, 1YY, 1ZZ, 2C and comparative control 2C2 copper-containing paint showed minimal growth in leachate toxicity assay after 0 days immersion. No significant difference was exhibited with or without TBBA. The surface generated with RESIN 3 or RESIN 4 brominated epoxy resin was comparable to RESIN 1. The RESIN 2 resin system exhibited reduced toxicity. Addition of dispersant/pigment/fillers/new solvent blend did not significantly affect toxicity of RESIN 3 or 4 systems. The 2K systems were slightly less toxic in leachate. Removing Econea and zinc pyrithione biocides, e.g., in 2D, rendered leachate as non-toxic.

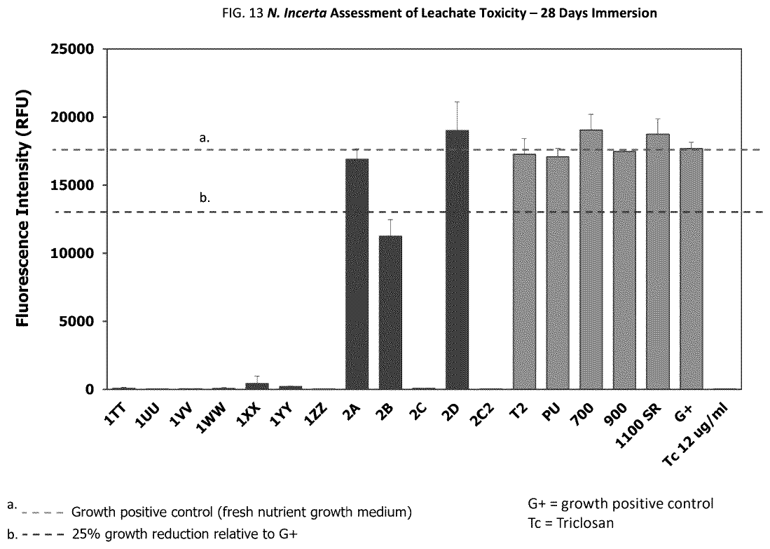

FIG. 13 shows results of N. incerta assessment of brown microalgal leachate toxicity after 28 days immersion as a bar graph of fluorescence intensity (RFU) for the test formulations 1TT, 1UU, 1VV, 1WW, 1XX, 1YY, 1ZZ, 2A, 2B, 2C, 2D and control formulations 2C2, T2, PU, 700, 900, 1100SR. G+ is the growth positive control, Tc is Triclosan. Formulations 1TT, 1UU, 1VV, 1WW, 1XX, 1YY, 1ZZ, 2C and comparative control 2C2 copper-containing paint showed minimal growth in leachate toxicity assay after 28 days immersion. In this data similar trends were seen as at 0 days water immersion except RESIN 2 (1XX) now shows significant toxicity after 28 days. The 2K systems have become significantly less toxic. Replacing RESIN 1 (1TT) with non-brominated equivalent RESIN 7 (2C) in otherwise similar formulation still has significant toxicity under these conditions. The RESIN 1 system without Econea and zinc pyrithione (2D) is not toxic to leachate.

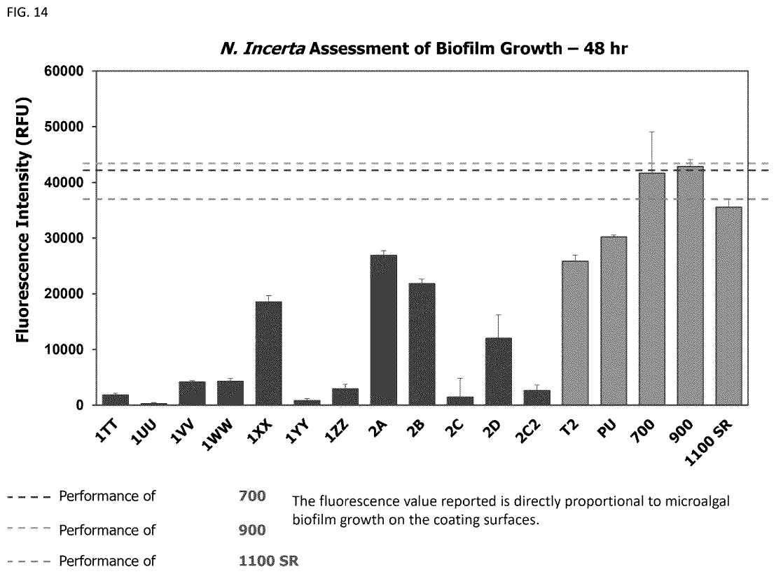

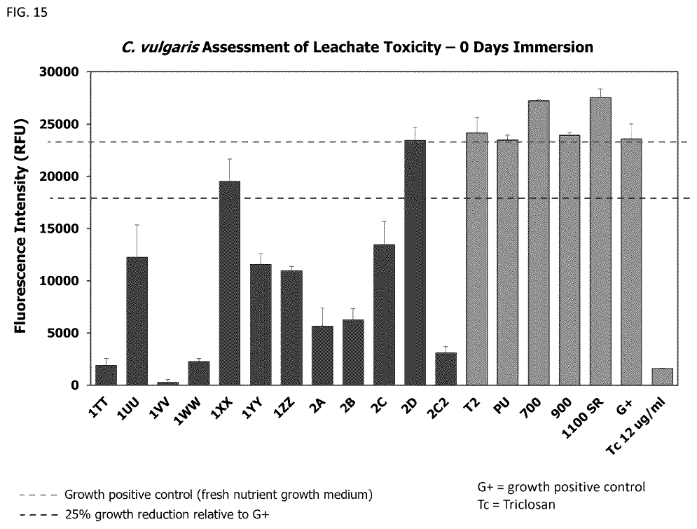

FIG. 14 shows results of N. incerta assessment of brown microalgal biofilm growth after 48 hours as a bar graph of fluorescence intensity (RFU) for the test formulations 1TT, 1UU, 1VV, 1WW, 1XX, 1YY, 1ZZ, 2A, 2B, 2C, 2D and control formulations 2C2, T2, PU, 700, 900, 1100SR. The fluorescence value is directly proportional to microalgal biofilm growth on the coating surfaces. Formulations 1TT, 1UU, 1VV, 1WW, 1YY, 1ZZ, and 2C and comparative control 2C2 copper-containing paint showed minimal microalgal biofilm growth after 48 hours. In this assay, similar results were seen with or without TBBA. Use of RESIN 3 (1WW, 1YY) or RESIN 4 (1ZZ) resin did not compromise properties. Surfaces when using RESIN 2 (1XX) showed significantly more growth than RESIN 1 containing samples (1TT, 1UU, 1VV). Removing Econea and zinc pyrithione biocides (2D) resulted in higher amounts of biofilm growth compared to similar systems.

FIG. 15 shows results of C. vulgaris assessment of green microalgal leachate toxicity after 0 days immersion as a bar graph of fluorescence intensity (RFU) for the test formulations 1TT, 1UU, 1VV, 1WW, 1XX, 1YY, 1ZZ, 2A, 2B, 2C, 2D and control formulations 2C2, T2, PU, 700, 900, 1100SR. G+ is the growth positive control, Tc is Triclosan. Formulations 1TT, 1VV, 1WW and comparative control 2C2 copper-containing paint showed minimal growth in leachate toxicity assay after 0 days immersion. Significantly less toxic leachate was observed when removing TBBA at 0 days immersion. There was no significant difference between RESIN 3 or RESIN 4 and RESIN 1 resin systems. The formulation with RESIN 2-A80 is significantly less toxic. The 2K systems showed slightly lower toxicity. Higher toxicity was exhibited in RESIN 1 system compared to non-brominated epoxy. Removing Econea and zinc pyrithione, e.g., in 2D, results in non-toxic surface.

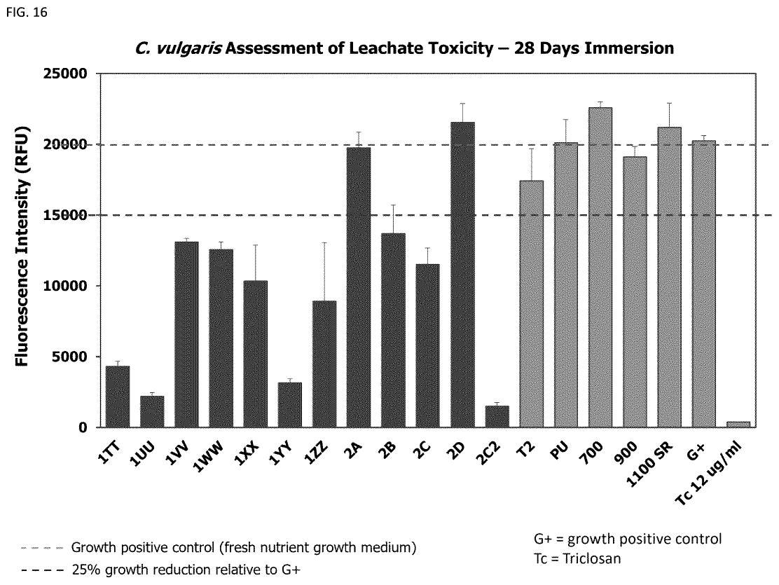

FIG. 16 shows results of C. vulgaris assessment of green microalgal leachate toxicity after 28 days immersion as a bar graph of fluorescence intensity (RFU) for the test formulations 1TT, 1UU, 1VV, 1WW, 1XX, 1YY, 1ZZ, 2A, 2B, 2C, 2D and control formulations 2C2, T2, PU, 700, 900, 1100SR. G+ is the growth positive control, Tc is Triclosan. Formulations 1TT, 1UU, 1YY and comparative control 2C2 copper-containing paint showed minimal growth in leachate toxicity assay after 28 days immersion. In this data set, the sample without TBBA is more toxic than the sample with TBBA. Tripling the amount of TBBA shows significantly lower toxicity. After longer immersion, sample with compositional changes in RESIN 3 or RESIN 4 system is more toxic. The 2K coatings now have lower toxicity after leaching for longer. The RESIN 1 formulation without Econea and zinc pyrithione, e.g., 2D, is still non-toxic.

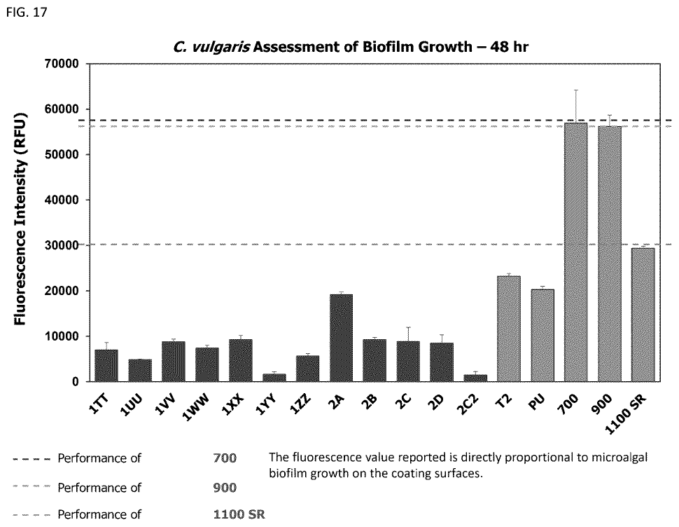

FIG. 17 shows results of C. vulgaris assessment of green microalgal biofilm growth after 48 hours as a bar graph of fluorescence intensity (RFU) for the test formulations 1TT, 1UU, 1VV, 1WW, 1XX, 1YY, 1ZZ, 2A, 2B, 2C, 2D and control formulations 2C2, T2, PU, 700, 900, 1100SR. G+ is the growth positive control, Tc is Triclosan.

The fluorescence value is directly proportional to microalgal biofilm growth on the coating surfaces. All test formulations 1TT, 1UU, 1VV, 1WW, 1XX, 1YY, 1ZZ, 2A, 2B, 2C, and 2D exhibited less biofilm growth than comparative formulations T2, PU, 700, 900 and 1100 SR after 48 hrs. Formulation 1YY and comparative control 2C2 copper-containing paint showed minimal biofilm growth after 48 hours. Low growth was seen in virtually all formulations. The lowest growth was seen on surfaces resulting from RESIN 3 or RESIN 4 systems. The highest growth was seen in one 2K system with a 1:1 curing ratio.

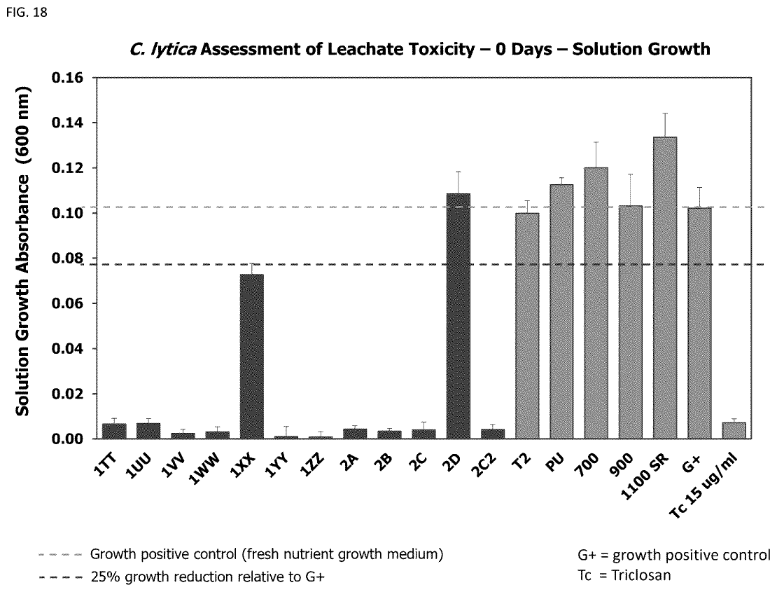

FIG. 18 shows results of C. lytica assessment of marine bacterium leachate toxicity after 0 days immersion as a bar graph of solution growth absorbance (600 nm) for the test and control formulations. G+ is the growth positive control, Tc is Triclosan. Formulations 1TT, 1UU, 1VV, 1WW, 1YY, 1ZZ, 2A, 2B, 2C and comparative control 2C2 copper-containing paint showed minimal growth in leachate toxicity assay after 0 days immersion. High toxicity was seen in all formulations except RESIN 2-A80 resin system and the coating without Econea and zinc pyrithione. Compositional changes to RESIN 3 or RESIN 4 resin formulations did not significantly impact toxicity of the leachate solution.

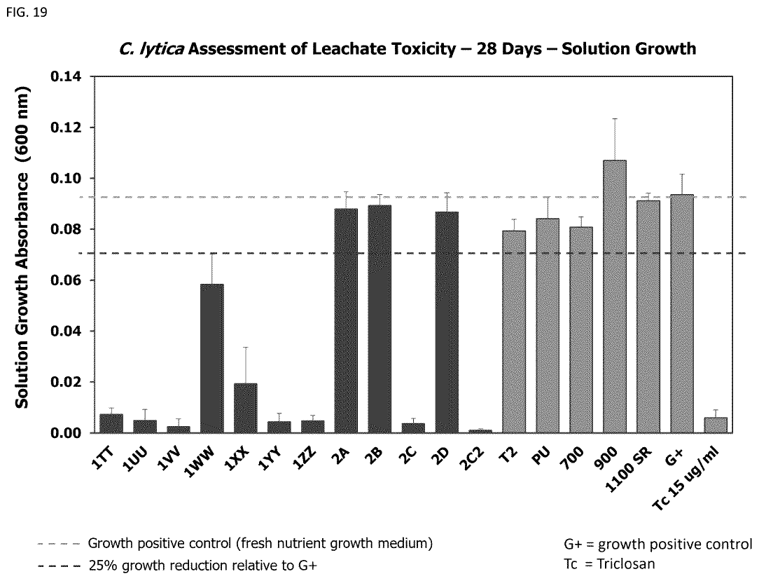

FIG. 19 shows results of C. lytica assessment of marine bacterium leachate toxicity after 28 days immersion as a bar graph of solution growth absorbance (600 nm) for the test and control formulations. G+ is the growth positive control, Tc is Triclosan. Formulations 1TT, 1UU, 1VV, 1YY, 1ZZ, 2C and comparative control 2C2 copper-containing paint showed minimal growth in leachate toxicity assay after 28 days immersion. After 28 days, growth in solution was still low for samples without TBBA. The sample with RESIN 2-A80 now shows increased toxicity compared to 0 days of leaching. The solutions exposed to 2K samples that were leached for 28 days are now considered toxic. Formulations having Econea and zinc pyrithione biocides removed exhibit low leachate toxicity.

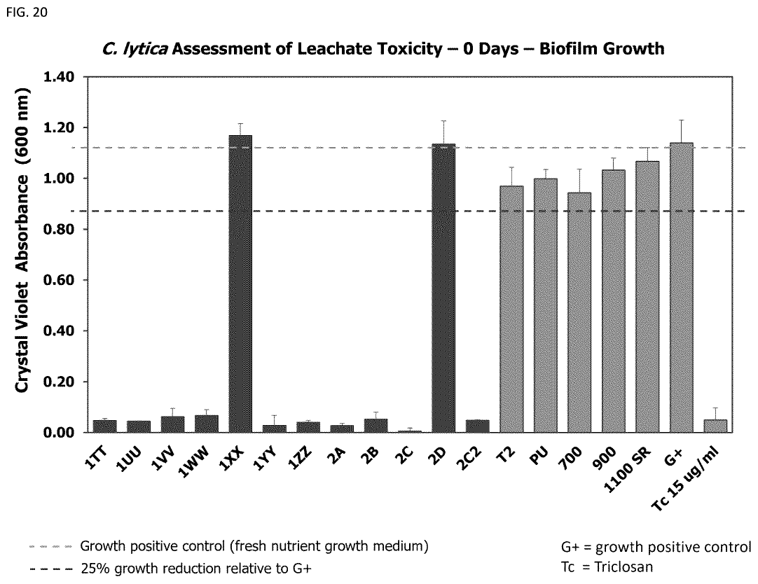

FIG. 20 shows results of C. lytica assessment of marine bacterium leachate toxicity biofilm growth after 0 days as a bar graph of crystal violet absorbance (600 nm) for the test and control formulations. Formulations 1TT, 1UU, 1VV, 1WW, 1YY, 1ZZ, 2A, 2B, and 2C and comparative control 2C2 copper-containing paint showed minimal biofilm growth after 0 days. Removing Econea and zinc pyrithione have a significantly detrimental effect on toxicity.

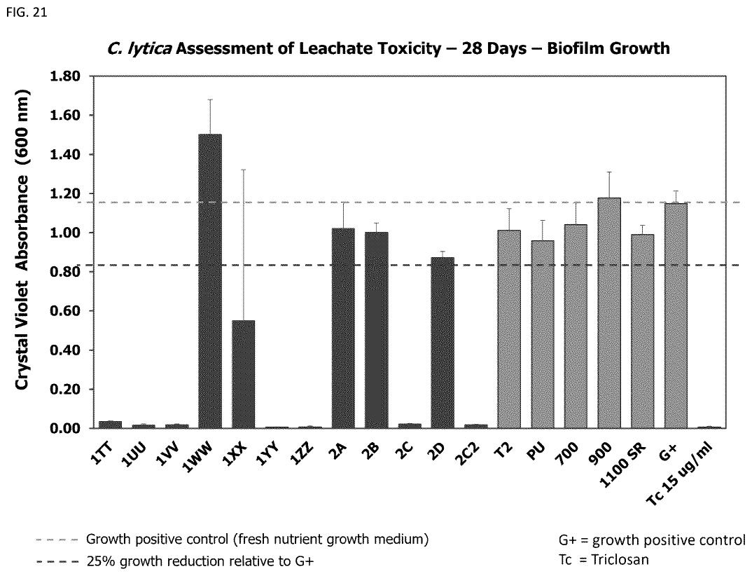

FIG. 21 shows results of C. lytica assessment of marine bacterium leachate toxicity biofilm growth after 28 days as a bar graph of crystal violet absorbance (600 nm) for the test and control formulations. Formulations 1TT, 1UU, 1VV, 1YY, 1ZZ, and 2C and comparative control 2C2 copper-containing paint showed minimal biofilm growth after 28 days. A similar trend is seen as shown with leachate toxicity of marine bacterium. No significant difference was observed toward biofilm with or without TBBA as well as compositional changes in RESIN 3 and RESIN 4 formulations.

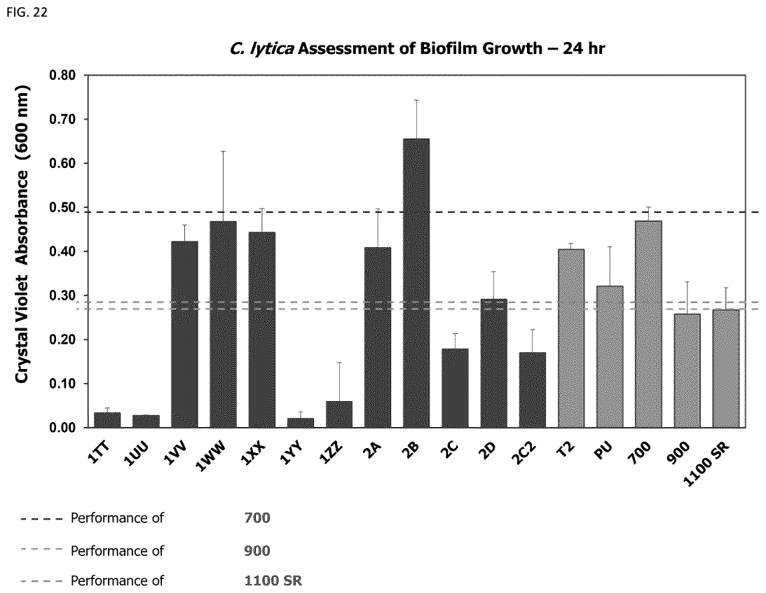

FIG. 22 shows results of C. lytica assessment of marine bacterium biofilm growth after 24 hours as a bar graph of crystal violet absorbance (600 nm) for the test and control formulations. Formulations 1TT, 1UU, 1YY, and 1ZZ showed minimal biofilm growth after 24 hours. No significant difference of biofilm growth on samples with or without TBBA. Tripling amount of TBBA increased growth of biofilm. Significantly higher growth was seen on 2K samples. Removing Econea and zinc pyrithione did not have as significant effect as in previous assays. The 2C2 copper-containing control also exhibited average biogrowth compared to experimental samples.

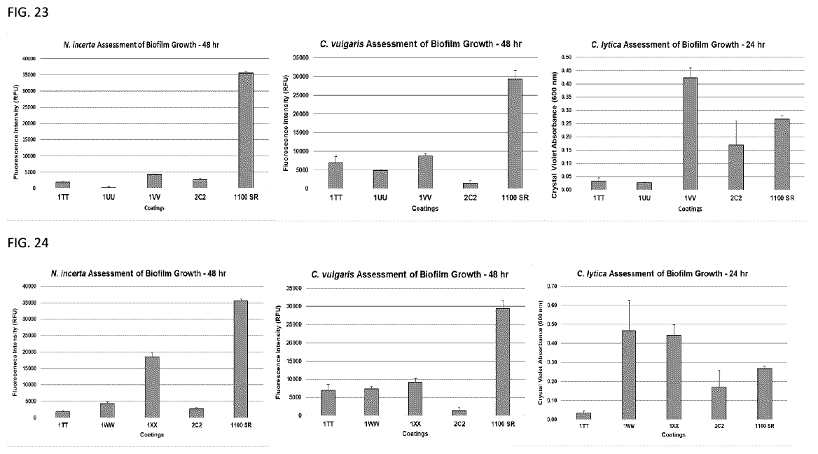

FIG. 23 shows bar graphs of assessment of biofilm growth for formulations 1TT, 1UU, 1VV, comparative copper-containing control 2C2 and 1100SR in N. incerta brown microalgal biofilm growth (left panel, fluorescence intensity (RFU) at 48 hr), C. vulgaris green microalgal biofilm growth (center panel, fluorescence intensity (RFU) at 48 hr), and C. lytica marine bacterium biofilm growth (right panel, crystal violet absorbance (600 nm) at 24 hr) biological assays. Compositions 1TT and 1UU exhibit low biofilm growth in each of the brown microalgal, green microalgal, and bacterium biofilm assays when compared to 1100SR.

FIG. 24 shows bar graphs of assessment of biofilm growth for formulations 1TT, 1WW, 1XX, comparative copper-containing control 2C2 and 1100SR in N. incerta brown microalgal biofilm growth (left panel, fluorescence intensity (RFU) at 48 hr), C. vulgaris green microalgal biofilm growth (center panel, fluorescence intensity (RFU) at 48 hr), and C. lytica marine bacterium biofilm growth (right panel, crystal violet absorbance (600 nm) at 24 hr) biological assays. Composition 1TT exhibits low biofilm growth in each of the brown microalgal, green microalgal, and bacterium biofilm assays when compared to 1100SR.

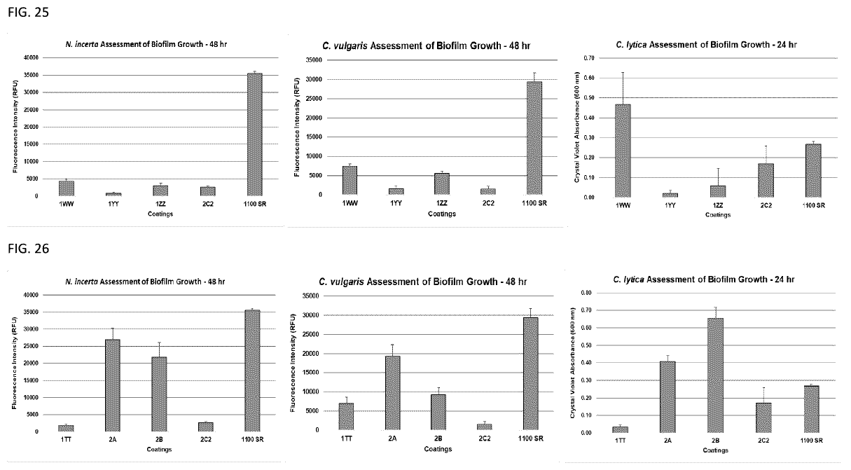

FIG. 25 shows bar graphs of assessment of biofilm growth for formulations 1WW, 1YY, 1ZZ, comparative copper-containing control 2C2 and 1100SR in N. incerta brown microalgal biofilm growth (left panel, fluorescence intensity (RFU) at 48 hr), C. vulgaris green microalgal biofilm growth (center panel, fluorescence intensity (RFU) at 48 hr), and C. lytica marine bacterium biofilm growth (right panel, crystal violet absorbance (600 nm) at 24 hr) biological assays. Compositions 1YY and 1ZZ exhibit low biofilm growth in each of the brown microalgal, green microalgal, and bacterium biofilm assays when compared to 1100SR. Compositions 1YY and 1ZZ exhibit less biofilm growth compared to copper-containing control 2C2 in the bacterium biofilm assay.

FIG. 26 shows bar graphs of assessment of biofilm growth for formulations 1TT, 2A, 2B, comparative copper-containing control 2C2 and 1100SR in N. incerta brown microalgal biofilm growth (left panel, fluorescence intensity (RFU) at 48 hr), C. vulgaris green microalgal biofilm growth (center panel, fluorescence intensity (RFU) at 48 hr), and C. lytica marine bacterium biofilm growth (right panel, crystal violet absorbance (600 nm) at 24 hr) biological assays. Composition 1TT exhibits low biofilm growth in each of the brown microalgal, green microalgal, and bacterium biofilm assays when compared to 1100SR. Composition 1TT exhibits less biofilm growth compared to copper-containing control 2C2 in the bacterium biofilm assay.

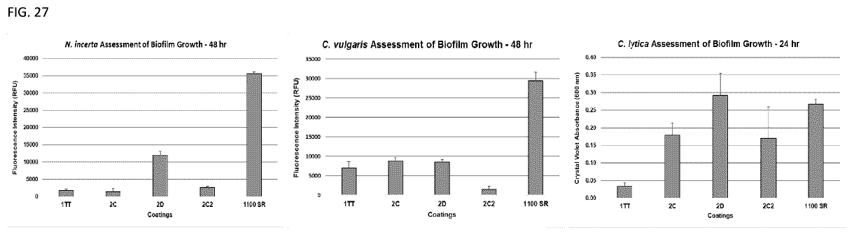

FIG. 27 shows bar graphs of assessment of biofilm growth for formulations 1TT, 2C, 2D, comparative copper-containing control 2C2 and 1100SR in N. incerta brown microalgal biofilm growth (left panel, fluorescence intensity (RFU) at 48 hr), C. vulgaris green microalgal biofilm growth (center panel, fluorescence intensity (RFU) at 48 hr), and C. lytica marine bacterium biofilm growth (right panel, crystal violet absorbance (600 nm) at 24 hr) biological assays. Composition 1TT exhibits low biofilm growth in each of the brown microalgal, green microalgal, and bacterium biofilm assays when compared to 1100SR. Composition 1TT exhibits less biofilm growth compared to copper-containing control 2C2 in the bacterium biofilm assay.

### REFERENCES

Benda, J., Stafslien, S., Vanderwal, L., Finlay, J. A., Clare, A. S., & Webster, D. C. (2021). Surface modifying amphiphilic additives and their effect on the fouling-release performance of siloxane-polyurethane coatings. Biofouling, 37(3), 309-326. doi.org/10.1080/08927014.2021.1901891
Cassé, F., Ribeiro, E., Ekin, A., Webster, D. C., Callow, J. A., & Callow, M. E. (2007). Laboratory screening of coating libraries for algal adhesion. Biofouling, 23(4), 267-276. doi.org/10.1080/08927010701288336
Stafslien, S., Daniels, J., Mayo, B., Christianson, D., Chisholm, B., Ekin, A., Swain, G. (2007). Combinatorial materials research applied to the development of new surface coatings IV. A high-throughput bacterial biofilm retention and retraction assay for screening fouling-release performance of coatings. Biofouling, 23(1), 45-54. doi.org/10.1080/08927010601137856
Shane J. Stafslien, James A. Bahr, Justin W. Daniels, Lyndsi Vander Wal, Jonathan Nevins, Jeremy Smith, Kris Schiele, Bret Chisholm; Combinatorial materials research applied to the development of new surface coatings VI: An automated spinning water jet apparatus for the high-throughput characterization of fouling-release marine coatings. Rev. Sci. Instrum. 1 Jul. 2007; 78 (7): 072204. doi.org/10.1063/1.2755965
Majumdar, P., Lee, E., Patel, N., Ward, K., Stafslien, S. J., Daniels, J., . . . Thompson, S. E. M. (2008). Combinatorial materials research applied to the development of new surface coatings IX: An investigation of novel antifouling/fouling-release coatings containing quaternary ammonium salt groups. Biofouling, 24(3), 185-200. doi.org/10.1080/08927010801894660
Cassé, F., Stafslien, S. J., Bahr, J. A., Daniels, J., Finlay, J. A., Callow, J. A., & Callow, M. E. (2007). Combinatorial materials research applied to the development of new surface coatings V. Application of a spinning water-jet for the semi-high throughput assessment of the attachment strength of marine fouling algae. Biofouling, 23(2), 121-130. doi.org/10.1080/08927010701189583
Callow, M. E., Callow, J. A., Conlan, S., Clare, A. S. and Stafslien, S. (2014). Efficacy testing of nonbiocidal and fouling-release coatings. In Biofouling Methods (eds S. Dobretsov, J. C. Thomason and D. N. Williams). doi.org/10.1002/9781118336144.ch10

### CLAUSES

Clause 1. An antifouling coating composition comprising a brominated epoxy resin and one or more antifouling agents.

Clause 2. An antifouling coating composition comprising a brominated epoxy resin and a brominated additive.

Clause 3. The antifouling coating composition of clause 1 or 2, further comprising a surface additive.

Clause 4. The antifouling coating composition of clause 2 or 3, further comprising an antifouling agent.

Clause 5. An antifouling coating composition comprising a brominated epoxy resin, a brominated additive, a surface additive, and antifouling agent.

Clause 6. An antifouling coating composition comprising a brominated epoxy resin, a surface additive, and antifouling agent.

Clause 7. The composition of any one of clauses 1-6, wherein the brominated epoxy resin exhibits an EEW on solids (g/eq) in a range of between 305-470 g/eq by ASTM D-1652.

Clause 8. The composition of any one of clauses 1-7, wherein the brominated epoxy resin is a solvent based brominated epoxy resin or a solid brominated epoxy resin.

Clause 9. The composition of clause 8, wherein the solvent based brominated epoxy resin is made from a composition comprising 3,3′,5,5′-tetrabromobisphenol A and epichlorohydrin, or 2,2-bis[3,5-dibromo-4-(2,3-epoxypropoxy)phenyl]propane; and a solvent.

Clause 10. The composition of any one of clauses 1-9, wherein the brominated epoxy resin comprises one or more additional additives selected from the group consisting of a solvents, curing agents, accelerators, elasticizers, diluents, defoaming agents, wetting agents, dispersing agents, surfactants, adhesion promoters, thixotropic agents, drying agent, fillers, pigments, and coloring agents.

Clause 11. The composition of any one of clauses 2-5 and 7-10, wherein the brominated additive is selected from the group consisting of a nonreactive brominated additive and/or a reactive brominated additive.

Clause 12. The composition of any one of clauses 2-5 and 7-11, wherein the brominated additive is an aromatic reactive brominated additive, optionally selected from the group consisting of a tetrabromobisphenol A, tetrabromophthalic anhydride, dibromostyrene, pentabromophenol, and tribromophenol.

Clause 13. The composition of any one of clauses 2-5 and 7-11, wherein the brominated additive is an aliphatic reactive brominated additive, optionally selected from bromoform, vinyl bromide, ethylene bromohydrin, and dibromoneopentyl glycol.

Clause 14. The composition of any one of clauses 2-5 and 7-11, wherein the brominated additive is a nonreactive brominated additive, optionally selected from the group consisting of nonreactive aromatic brominated additives, nonreactive aliphatic brominated additives, and nonreactive cycloaliphatic brominated additives.

Clause 15. The composition of anyone of clauses 3-14, wherein the surface additive is a functional polydimethylsiloxane, optionally selected from the group consisting of epoxy-functional polydimethylsiloxane, hydroxy-functional polydimethylsiloxane, and amine-functional polydimethylsiloxane.

Clause 16. The composition of clause 15, wherein the surface additive comprises an epoxy-functional polydimethylsiloxane and a hydroxy-functional polydimethylsiloxane.

Clause 17. The composition of any one of clauses 1 and 4-16, wherein the antifouling agent is a non-persistent antifouling agent, optionally selected from the group consisting of tralopyril (4-bromo-2-(4-chlorophenyl)-5-(trifluoromethyl)-1H-pyrrole-3-carbonitrile), bronopol (2-bromo-2-nitro-propane-1,3-diol), dichlofluanid, 2,2′-dibromo-3-nitrilopropionamide, bis(1,4-bromoacetoxy)-2-butene, bis-(bromomethyl)sulfone, 1,2-dibromo-2,4-dicyanobutane, benzyl 2-bromoacetate, tetrabromobenzo-1,3-dinitrile, 4,5-dichloro-2-n-octyl-4-isothiazolin-3-one, and zinc ethylenebis(dithiocarbamate), and zinc pyrithione.

Clause 18. An antifouling coating composition comprising 60-95 wt % of a brominated epoxy resin, 1-20 wt % of a brominated additive, 0-20 wt % of a surface additive, and 0-20 wt % of an antifouling agent.

Clause 19. The antifouling coating composition of clause 18, comprising 60-95 wt % of the brominated epoxy resin, 1-20 wt % of the brominated additive, 0.1-20 wt % of the surface additive, and 0-20 wt % of the antifouling agent.

Clause 20. The antifouling coating composition of clause 18 or 19, comprising 70-90 wt % of the brominated epoxy resin, 5-10 wt % of the brominated additive, 1-20 wt % of the surface additive, and 0.5-20 wt % of the antifouling agent.

Clause 21. The antifouling coating composition of any one of clauses 18-20, wherein the brominated epoxy resin is a solvent based brominated epoxy resin.

Clause 22. The antifouling coating composition of any one of clauses 18-21, wherein the brominated additive is an aromatic reactive brominated additive.

Clause 23. The antifouling coating composition of any one of clauses 18-22, wherein the surface additive comprises an epoxy-functional polydimethylsiloxane and a polyester-modified, hydroxy-functional polydimethylsiloxane.

Clause 24. The antifouling coating composition of any one of clauses 18-23, wherein the antifouling agent includes a non-persistent antifouling agent, optionally wherein the non-persistent antifouling agent is selected from the group consisting of tralopyril (4-bromo-2-(4-chlorophenyl)-5-(trifluoromethyl)-1H-pyrrole-3-carbonitrile), bronopol (2-bromo-2-nitro-propane-1,3-diol), dichlofluanid, 2,2′-dibromo-3-nitrilopropionamide, bis(1,4-bromoacetoxy)-2-butene, bis-(bromomethyl)sulfone, 1,2-dibromo-2,4-dicyanobutane, benzyl 2-bromoacetate, tetrabromobenzo-1,3-dinitrile, 4,5-dichloro-2-n-octyl-4-isothiazolin-3-one, and zinc ethylenebis(dithiocarbamate), and zinc pyrithione.

Clause 25. The antifouling coating composition of any one of clauses 18-24, wherein the antifouling agent comprises tralopyril and zinc pyrithione.

Clause 26. A method of making an antifouling coating composition according to any one of clauses 1-25 comprising blending a brominated epoxy resin in a solvent with an antifouling agent using high shear mixing; optionally adding a surface additive during the mixing; and further optionally adding an brominated additive during the mixing to provide the antifouling coating composition.

Clause 27. A method of reducing fouling of underwater surfaces of a freshwater or marine vessel comprising exposing at least a portion of the underwater surfaces above waterline; applying the antifouling coating composition of any one of clauses 1 to 25 to at least a portion of the exposed surfaces below the waterline; and allowing the composition to dry/cure to form coated underwater surfaces.

Clause 28. A method of reducing fouling of a surface adapted to be submerged under water, the method comprising applying the antifouling coating composition of any one of clauses 1-25 to the surface while the surface is not submerged to provide an antifouling coating on the surface.

Clause 29. A method of reducing fouling of a surface adapted to be submerged under water, the method comprising applying an antifouling coating composition comprising a brominated epoxy resin to the surface while the surface is not submerged to provide an antifouling coating on the surface.

Clause 30. The method of clause 28 or 29, further comprising allowing the composition to dry or cure on the surface.

Clause 31. The method of any one of clauses 28-30, wherein the antifouling coating composition further comprises one or more or two or more antifouling agents, and optionally a surface additive.

Clause 32. The method of any one of clauses 28-31, wherein the surface adapted to be submerged under water is selected from the group consisting of a freshwater or marine vessel, hull, propeller, shaft, strut, trim tabs, intake, intake cover, transducer, knotmeter, keel cooler, grounding plate, line cutter, dock, oil rig, crane, support structure, and buoy.

Clause 33. The method of any one of clauses 28-32, wherein the antifouling coating on the surface is self-ablative and self-polishing in seawater.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. An antifouling coating composition comprising a brominated epoxy resin and one or more antifouling agents.

2. The antifouling coating composition of claim 1, further comprising a brominated additive.

3. The antifouling coating composition of claim 1, further comprising a surface additive.

4. The antifouling coating composition of claim 1, comprising the brominated epoxy resin, the one or more antifouling agents, a brominated additive, and a surface additive.

5. The composition of claim 1, wherein the brominated epoxy resin exhibits an EEW on solids (g/eq) in a range of between 305-470 g/eq by ASTM D-1652.

6. The composition of claim 1, wherein the brominated epoxy resin is a solvent based brominated epoxy resin or a solid brominated epoxy resin.

7. The composition of claim 6, wherein the solvent based brominated epoxy resin is made from a composition comprising 3,3′,5,5′-tetrabromobisphenol A and epichlorohydrin, or 2,2-bis[3,5-dibromo-4-(2,3-epoxypropoxy)phenyl]propane; and a solvent.

8. The composition of claim 1, further comprising one or more additional additives selected from the group consisting of a solvent, curing agent, accelerator, elasticizer, diluent, defoaming agent, wetting agent, dispersing agent, surfactant, adhesion promoter, thixotropic agent, drying agent, filler, pigment, and coloring agent.

9. The composition of claim 2, wherein the brominated additive is selected from the group consisting of a nonreactive brominated additive and/or a reactive brominated additive.

10. The composition of claim 2, wherein the brominated additive is an aromatic reactive brominated additive, optionally selected from the group consisting of a tetrabromobisphenol A, tetrabromophthalic anhydride, dibromostyrene, pentabromophenol, and tribromophenol.

11. The composition of claim 2, wherein the brominated additive is an aliphatic reactive brominated additive, optionally selected from bromoform, vinyl bromide, ethylene bromohydrin, and dibromoneopentyl glycol.

12. The composition of claim 2, wherein the brominated additive is a nonreactive brominated additive, optionally selected from the group consisting of nonreactive aromatic brominated additives, nonreactive aliphatic brominated additives, and nonreactive cycloaliphatic brominated additives.

13. The composition of claim 3, wherein the surface additive is a functional polydimethylsiloxane, optionally selected from the group consisting of epoxy-functional polydimethylsiloxane, hydroxy-functional polydimethylsiloxane, and amine-functional polydimethylsiloxane.

14. The composition of claim 13, wherein the surface additive comprises an epoxy-functional polydimethylsiloxane and a hydroxy-functional polydimethylsiloxane.

15. The composition of claim 1, wherein the one or more antifouling agents is a non-persistent antifouling agent, optionally selected from the group consisting of tralopyril (4-bromo-2-(4-chlorophenyl)-5-(trifluoromethyl)-1H-pyrrole-3-carbonitrile), bronopol (2-bromo-2-nitro-propane-1,3-diol), dichlofluanid (N-(dichlorofluoromethylthio)-N′,N′-dimethyl-N-phenylsulfamide), 2,2′-dibromo-3-nitrilopropionamide, diuron (3-(3,4-dichlorophenyl)-1,1-dimethylurea), medetomidine hydrochloride (4-[1-(2,3-dimethylphenyl)ethyl]-1H-imidazole, monohydrochloride, bis(1,4-bromoacetoxy)-2-butene, bis-(bromomethyl)sulfone, 1,2-dibromo-2,4-dicyanobutane, benzyl 2-bromoacetate, tetrabromobenzo-1,3-dinitrile, 4,5-dichloro-2-n-octyl-4-isothiazolin-3-one, zinc ethylenebis(dithiocarbamate), and zinc pyrithione.

16. The antifouling coating composition of claim 1, comprising 60-95 wt % of the brominated epoxy resin, 0.1-20 wt % of the one or more antifouling agents, 0-20 wt % of a brominated additive, and 0-20 wt % of a surface additive.

17. The antifouling coating composition of claim 16, comprising 60-95 wt % of the brominated epoxy resin, 0.1-20 wt % of the one or more antifouling agents, 0-20 wt % of a brominated additive, and 0.1-20 wt % of a surface additive.

18. The antifouling coating composition of claim 16, comprising 60-95 wt % of the brominated epoxy resin, 0.1-20 wt % of the one or more antifouling agents, 0.1-20 wt % of a brominated additive, and 0-20 wt % of a surface additive.

19. The antifouling coating composition of claim 16, comprising 60-90 wt % of the brominated epoxy resin, 0.1-20 wt % of the one or more antifouling agents, 0.1-20 wt % of a brominated additive, and 0.1-20 wt % of a surface additive.

20. The antifouling coating composition of claim 16, wherein the brominated epoxy resin is a solvent based brominated epoxy resin.

21. The antifouling coating composition of claim 16, wherein the brominated additive is an aromatic reactive brominated additive.

22. The antifouling coating composition of claim 16, wherein the surface additive is selected from the group consisting of an epoxy-functional polydimethylsiloxane, a polyester-modified hydroxy-functional polydimethylsiloxane, a hydrophilic modified non-reactive polysiloxane, a polyether modified polysiloxane, and a polypropylene modified polysiloxane.

23. The antifouling coating composition of claim 16, wherein the antifouling agent includes a non-persistent antifouling agent, optionally wherein the non-persistent antifouling agent is selected from the group consisting of tralopyril (4-bromo-2-(4-chlorophenyl)-5-(trifluoromethyl)-1H-pyrrole-3-carbonitrile), bronopol (2-bromo-2-nitro-propane-1,3-diol), dichlofluanid, 2,2′-dibromo-3-nitrilopropionamide, bis(1,4-bromoacetoxy)-2-butene, bis-(bromomethyl)sulfone, 1,2-dibromo-2,4-dicyanobutane, benzyl 2-bromoacetate, tetrabromobenzo-1,3-dinitrile, 4,5-dichloro-2-n-octyl-4-isothiazolin-3-one, and zinc ethylenebis(dithiocarbamate), and zinc pyrithione.

24. The antifouling coating composition of claim 16, wherein the antifouling agent comprises tralopyril and zinc pyrithione.

25. An antifouling coating composition comprising a brominated epoxy resin, a surface additive, and one or more antifouling agents.

26. A method of making an antifouling coating composition comprising blending a brominated epoxy resin in a solvent using high shear mixing; optionally adding a surface additive during the mixing; and further optionally adding one or more antifouling agents during the mixing to provide the antifouling coating composition.

27. A method of reducing fouling of a surface adapted to be submerged under water, the method comprising:
applying an antifouling coating composition comprising a brominated epoxy resin to the surface while the surface is not submerged to provide an antifouling coating on the surface.

28. The method of claim 27, further comprising allowing the composition to dry or cure on the surface.

29. The method of claim 27, wherein the antifouling coating composition further comprises one or more or two or more antifouling agents, and optionally a surface additive.

30. The method of claim 27, wherein the surface adapted to be submerged under water is selected from the group consisting of a freshwater or marine vessel, hull, propeller, shaft, strut, trim tabs, intake, intake cover, transducer, knotmeter, keel cooler, grounding plate, line cutter, dock, oil rig, crane, support structure, and buoy.

31. The method of claim 27, wherein the antifouling coating on the surface is self-ablative and self-polishing in seawater.
